(19) United States
(12) Patent Application Publication
(10) Pub. No.: US 2023/0367589 A1
(43) Pub. Date: Nov. 16, 2023

(54) DEVELOPMENT ASSISTANCE SYSTEM AND DEVELOPMENT ASSISTANCE METHOD

(71) Applicant: Hitachi, Ltd., Tokyo (JP)

(72) Inventors: Hiroki TAKAMATSU, Tokyo (JP); Shingo MAEDA, Tokyo (JP)

(73) Assignee: Hitachi, Ltd., Tokyo (JP)

(21) Appl. No.: 18/178,960

(22) Filed: Mar. 6, 2023

(30) Foreign Application Priority Data
May 13, 2022 (JP) 2022-079404

(51) Int. Cl. G06F 8/73; G06F 8/71; G06F 11/36

(52) U.S. Cl. CPC G06F 8/73; G06F 8/71; G06F 11/3636

(57) ABSTRACT

A development assistance system includes a source code information registration section that reads execution trace information containing information that associates a source code of a program with a test item for executing a test for a function of predetermined software, the program running when the test is executed by a test execution system based on test information containing the test item, identifies edge information with which a test item node representing a test item that coincides with the test item in the read execution trace information is associated from the edge information registered by the test item information registration section, identifies a function node with which the test item node is associated based on the identified edge information, and registers edge information for setting an edge representing the relationship between the identified function node and a source code node of the source code.

### CROSS-REFERENCE TO RELATED APPLICATION

This application claims priority pursuant to 35 U.S.C. § 119 from Japanese Patent Application No. 2022-079404, filed on May 13, 2022, the entire disclosure of which is hereby incorporated herein by reference.

### BACKGROUND

### Technical Field

The present invention relates generally to a technology for assisting development of existing software.

### Description of the Related Art

### Related Art

Most software development projects in recent years have been derivative development that adds functions to or changes or otherwise modifies the functions of existing software. To develop high-quality software in a short period of time in the derivative development, it is important to understand the entire software, such as the specifications and the source codes of the existing software. In software having evolved into large and complex software through repeated functional additions and changes, it has become difficult to understand the entire software, resulting in a large number of person-hours and difficulty in ensuring the quality of the software.

One of the measures is to make it possible to trace the relationship between documents, such as the specifications and source codes, in the software development (ensure traceability). Ensuring the traceability makes it easy to examine the influence of software modifications, and allows assistance of the development of high-quality software in a short period of time.

There are two ways to associate documents, such as specifications and source codes, with each other: The documents are associated with each other manually; and unique tags are embedded in the documents when the documents are created, and the documents are associated with each other based on the tags.

In derivative development, which involves many specifications and source codes, however, the related-art method for manually associating documents to each other or embedding tags may result in omission of the association operation or wrong association operation, which leads to incorrect document relationship information representing the relationship between documents. In this case, it is necessary to manually review all the documents and correct the document relationship information in order to distinguish locations where the documents are correctly associated with each other from locations where the documents are incorrectly associated with each other, which requires an enormous person-hours.

In this regard, Japanese Translation of PCT Internal Application Publication No. 2017-517821 (Patent Literature 1) discloses a technology for automating important aspects of software development, such as technologies for automatically identifying the latest version of a software file and automatically locating software defects (See Patent Literature 1).

### SUMMARY OF THE INVENTION

The technology described in Patent Literature 1 can utilize knowledge from existing software files to allow a user to grasp each element of the software, but does not allow the user to grasp the relationship between the elements of the software and therefore cannot properly assist the development of the software.

The present invention has been made in view of the points described above, and attempts to propose a development assistance system and the like that can appropriately assist the development of existing software.

To achieve the object described above, in the present invention, a development assistance system includes a function information registration section that registers node information for setting a function node and edge information for setting an edge representing a relationship between function nodes based on document information relating to predetermined software, a test item information registration section that registers node information for setting a test item node and edge information for setting an edge representing a relationship between a test item node and a function node based on test information containing a test item for performing a test on a function of the predetermined software, and a source code information registration section that registers node information for setting a source code node based on a source code used in the predetermined software, and the source code information registration section reads execution trace information containing information that associates a source code of a program with the test item for executing the test for a function of the predetermined software, the program running when the test is executed by a test execution system based on the test information containing the test item, identifies the edge information with which a test item node representing a test item that coincides with the test item in the read execution trace information is associated from the edge information registered by the test item information registration section, identifies a function node with which the test item node is associated based on the identified edge information, and registers edge information for setting an edge representing a relationship between the identified function node and the source code node of the source code.

In the configuration described above, for example, the function and the source code are automatically associated with each other by using an explanation note of the test content described in the test item and the test execution trace. No omission of the association operation or wrong association operation therefore occurs, whereby a correct relationship between a function and a source code is established. In addition, the association operation performed manually or by embedding tags is unnecessary, whereby high-quality software can be developed in a short period of time, and development and maintenance person-hours can be reduced.

The present invention can appropriately assist development of existing software. Objects, configurations, and effects other than those described above will be apparent from the following description of an embodiment.

### BRIEF DESCRIPTION OF THE DRAWINGS

FIG. 1 shows an example of the configuration of a development assistance system according to a first embodiment;

FIG. 2A shows images of how to associate elements of existing software to each other according to the first embodiment;

FIG. 2B shows images of how to associate the elements of the existing software to each other according to the first embodiment;

FIG. 3 shows an example of a test item table according to the first embodiment;

FIG. 4 shows an example of graph information according to the first embodiment;

FIG. 5 shows an example of execution trace information according to the first embodiment;

FIG. 6 shows an example of an extraction process according to the first embodiment;

FIG. 7 shows another example of the extraction process according to the first embodiment;

FIG. 8 shows another example of the extraction process according to the first embodiment;

FIG. 9 shows another example of the extraction process according to the first embodiment;

FIG. 10 shows an example of an execution trace acquisition process according to the first embodiment;

FIG. 11 shows an example of a complementation process according to the first embodiment;

FIG. 12 shows an example of a function name similarity evaluation process according to the first embodiment;

FIG. 13 shows an example of a search process according to the first embodiment;

FIG. 14 shows an example of a display process according to the first embodiment;

FIG. 15 shows an example of a call graph display process according to the first embodiment;

FIG. 16 shows an example of a related function search process according to the first embodiment;

FIG. 17 shows an example of a related document reference process according to the first embodiment;

FIG. 18 shows an example of a screen according to the first embodiment;

FIG. 19 shows an example of the screen according to the first embodiment;

FIG. 20 shows an example of the screen according to the first embodiment;

FIG. 21 shows an example of the screen according to the first embodiment;

FIG. 22 shows an example of the screen according to the first embodiment;

FIG. 23 shows an example of the screen according to the first embodiment;

FIG. 24 shows an example of the screen according to the first embodiment;

FIG. 25 shows an example of the screen according to the first embodiment; and

FIG. 26 shows an example of the screen according to the first embodiment.

### DETAILED DESCRIPTION OF THE EMBODIMENTS

### (I) First Embodiment

An embodiment of the present invention will be described below in detail. It is, however, noted that the present invention is not limited to the embodiments.

Notations such as “first,” “second,” “third,” and so on in the present specification and other documents are added to identify components and do not necessarily limit the number or order of components. The numbers used to identify the components are used on a context basis, so that a number used in one context does not necessarily indicate the same configuration in other contexts. A component identified by a certain number is allowed to also perform the function of a component identified by another number.

The embodiment of the present invention will next be described with reference to the drawings. The following description and drawings are presented by way of example to describe the present invention, and omission and simplification of the description are made as appropriate for clarity of the description. The present invention can also be implemented in a variety of other forms. Unless otherwise restricted, each component may be described in the singular or plural. In the following description, identical elements in the drawings have the same reference character, and no description of the identical elements will be made as appropriate.

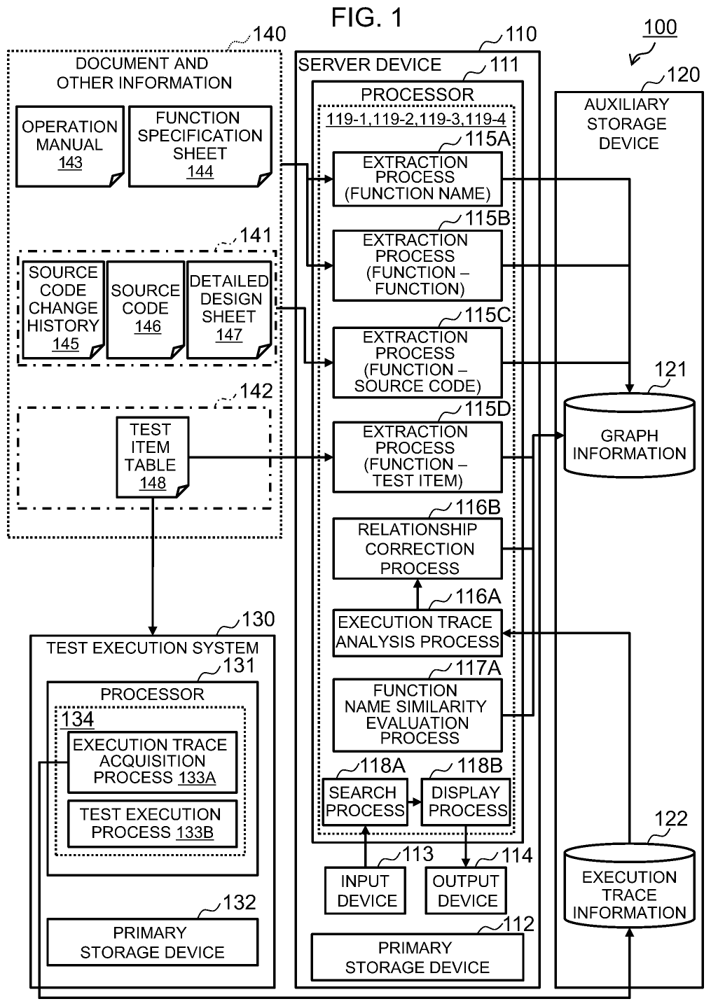

FIG. 1 shows an example of the configuration of a development assistance system 100 according to the present embodiment.

The development assistance system 100 includes a server device 110, an auxiliary storage device 120, and a test execution system 130.

The server device 110 is, for example, a traceability management system and can trace the relationships between documents, such as specifications and source codes, in software development. More specifically, the server device 110 includes a processor 111, a primary storage device 112, an input device 113, and an output device 114.

The processor 111 is a device that performs arithmetic operations. The processor 111 is, for example, a CPU (central processing unit), an MPU (micro processing unit), a GPU (graphics processing unit), or an AI (artificial intelligence) chip. The processor 111 carries out an extraction process (function name) 115A, an extraction process (function—function) 115B, an extraction process (function—source code) 115C, an extraction process (function—test item) 115D, an execution trace analysis process 116A, a relationship correction process 116B, a function name similarity evaluation process 117A, a search process 118A, a display process 118B, and other processes.

The primary storage device 112 is a device that stores a program, data, and other pieces of information. The primary storage device 112 is typically a memory, for example, a ROM (read only memory), a RAM (random access memory), and other memories. The ROM is, for example, an SRAM (static random access memory), an NVRAM (non volatile RAM), a mask ROM (mask read only memory), and a PROM (programmable ROM). The RAM is, for example, a DRAM (dynamic random access memory).

The input device 113 is a user interface that accepts information from a user. The input device 113 is, for example, a keyboard, a mouse, a card reader, or a touch panel.

The output device 114 is a user interface that outputs a variety of pieces of information (such as display output, audio output, printing output, and communication). The output device 114 is, for example, a display device, an audio output device (loudspeaker), a printing device, or a communication device. The display device is, for example, a liquid crystal display (LCD) or a graphics card. A communication device is a communication interface that communicates with other devices via a communication medium. The communication device is, for example, an NIC (network interface card), a wireless communication module, a USB (universal serial interface) module, or a serial communication module.

The functions of the server device 110 (such as function information registration section 119-1, test item information registration section 119-2, source code information registration section 119-3, and output section 119-4) may be realized, for example, by the processor 111 through reading the program stored in the auxiliary storage device 120 into the primary storage device 112 and executing the program (via software), by hardware such as a dedicated circuit, or by a combination of software and hardware. One function of the server device 110 may be divided into a plurality of functions, or a plurality of functions of the server device 110 may be combined with one another into one function. Part of the functions of the server device 110 may be provided as another function or provided as part of another function. Part of the functions of server device 110 may be achieved by another computer that can communicate with the server device 110.

The auxiliary storage device 120 is a device that stores a variety of types of data, such as a hard disk drive, a flash memory, a solid-state drive (SSD), or an optical storage device. The optical storage device is, for example, a CD (compact disc) or a DVD (digital versatile disc). The auxiliary storage device 120 stores graph information 121, execution trace information 122, and other pieces of information. The program, data, and other pieces of information stored in the auxiliary storage device 120 are read into the primary storage device 112 at any time. The auxiliary storage device 120 may be part of the server device 110, or part of the data in the auxiliary storage device 120 may be stored in the server device 110.

The graph information 121 is information that allows management of nodes and the relationship between the nodes, and may be, for example, a graph database (graph DB). The graph DB includes information on three elements: nodes, edges, and properties. The nodes are each an entity representing the name of a document and other information 140, the name of a function (function name), the name of a test item (test item name), and other factors. For example, the nodes are each expressed by a circle in a graph, which is a network-shaped data representation. The edges are each a connection representing the relationship between nodes. For example, the edges are each expressed by an arrow in the graph. The properties are each an attribute representing the nature of a node or an edge.

The test execution system 130 includes a processor 131 and a primary storage device 132. The processor 131 is identical to the processor 111. The processor 131 carries out an execution trace acquisition process 133A, a test execution process 133B, and other processes. The primary storage device 132 is identical to the primary storage device 112 and will therefore not be described. The functions of the test execution system 130 (execution section 134, for example) may be realized, for example, by the processor 131 through reading a program stored in an auxiliary storage device or any other component that is not shown into the primary storage device 132 and executing the program (via software), by hardware such as a dedicated circuit, or by a combination of software and hardware.

In the development assistance system 100, the server device 110 reads the document and other information 140 relating to the development of existing software and associates each element (such as document and other information 140, function, and test item) relating to the software with each other based on the result of a test executed by the test execution system 130. The document and other information 140 is document data relating to the existing software, and includes a source-code-related document 141 relating to the contents of processes carried out in the software, a test-related document 142 relating to tests of the functions of the software, an operation manual 143, a function specification sheet 144, and other pieces of information. Examples of the source-code-related document 141 may include a source code change history 145, a source code 146, a detailed design sheet 147, and other pieces of information. An example of the test-related document 142 may include a test item table 148.

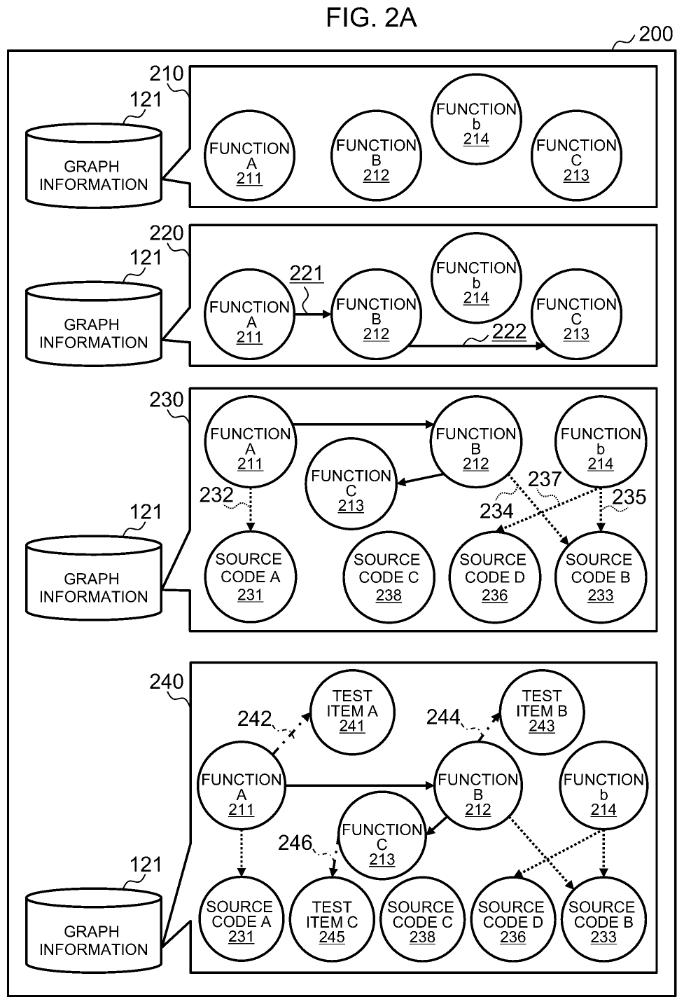

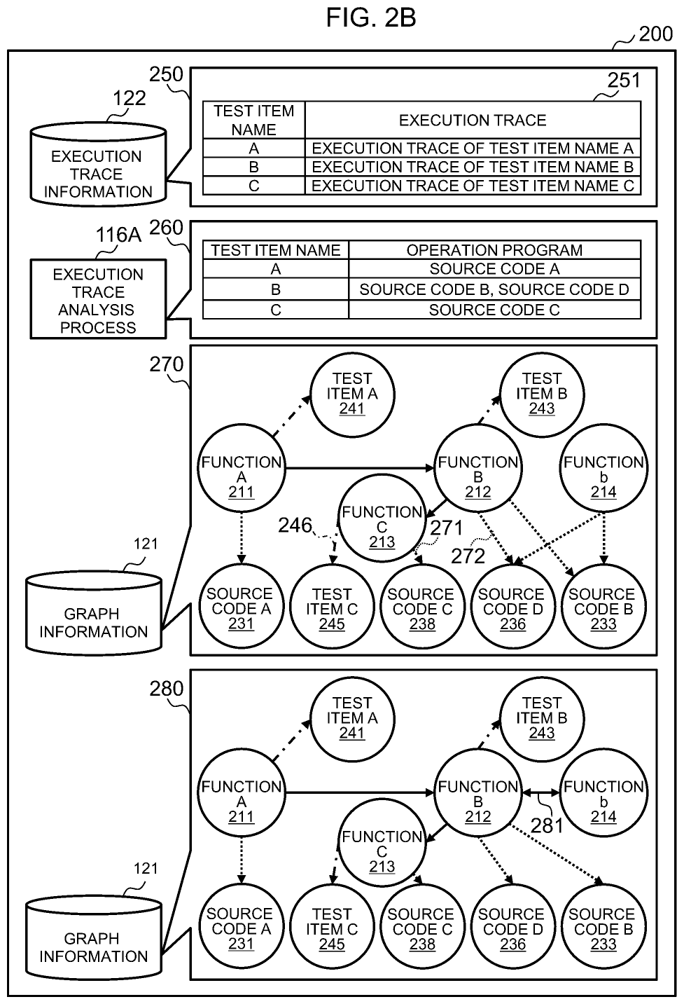

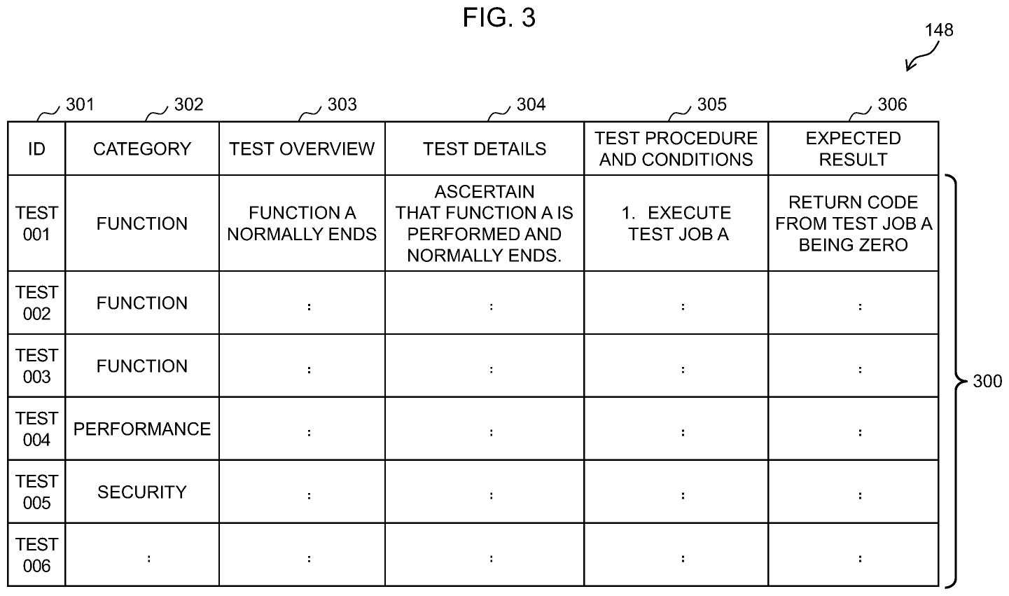

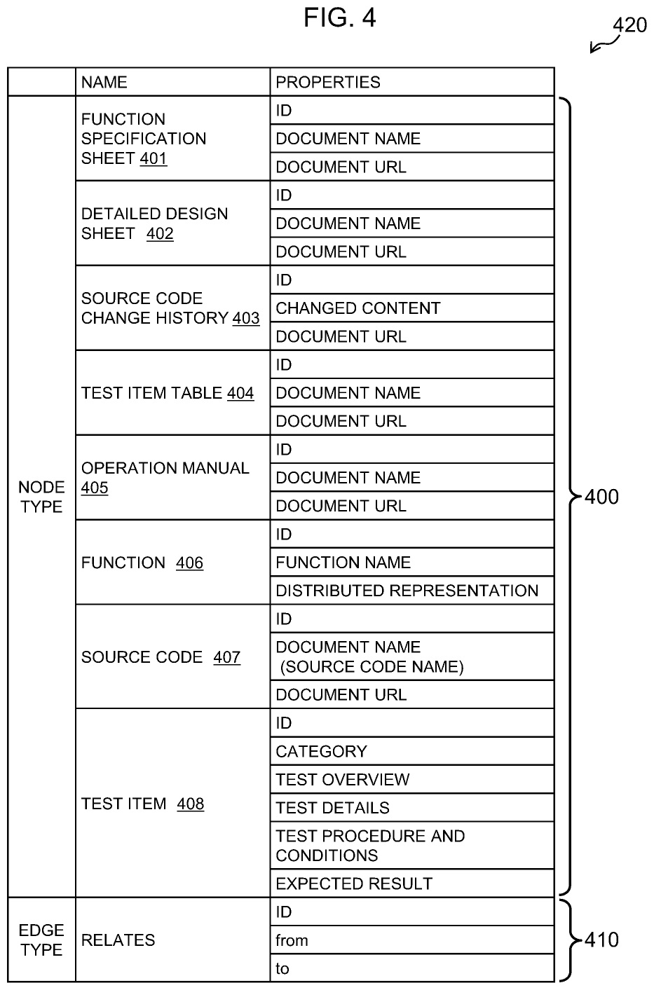

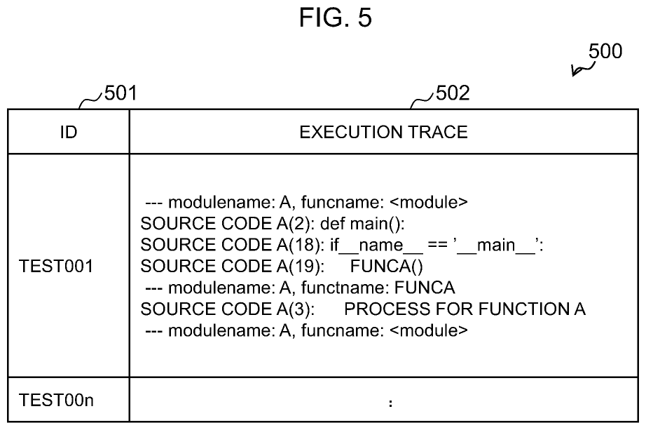

An overview of processes carried out by the server device 110 and the test execution system 130 will be described later with reference to FIGS. 2A and 2B. The test item table 148 will be described later with reference to FIG. 3. The graph information 121 will be described later with reference to FIG. 4. The execution trace information 122 will be described later with reference to FIG. 5.

FIGS. 2A and 2B show images of how to associate the elements of the existing software to each other in the development assistance system 100.

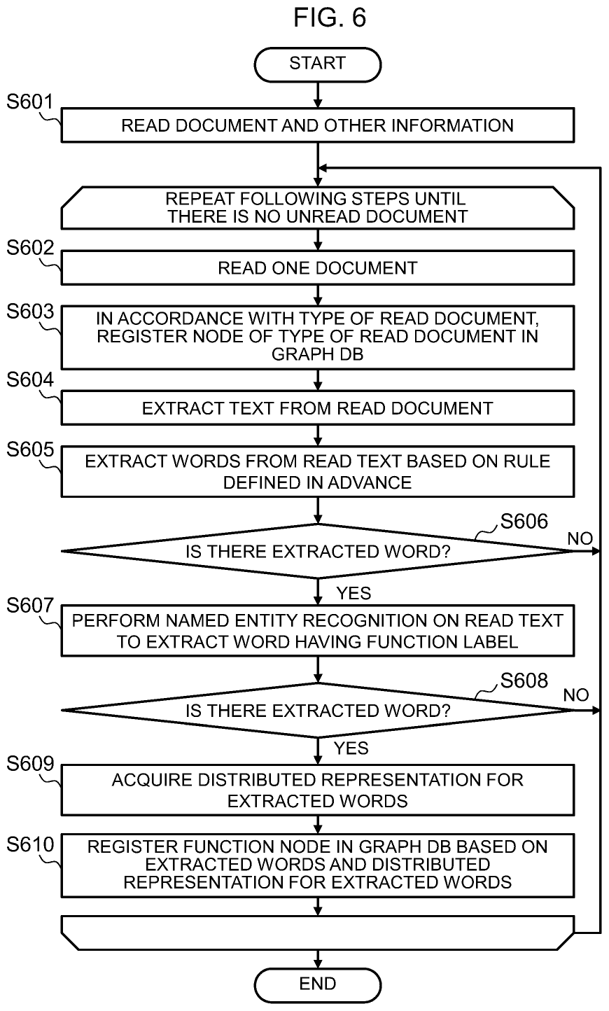

An image 210 is an image showing the result of the extraction process (function name) 115A. In the extraction process (function name) 115A, the server device 110, for example, reads the document and other information 140, extracts a function name from the read document and other information 140, and registers the extracted function name in the graph information 121. The image 210 shows an example in which functions A211, B212, C213, and b214 have been extracted each as the function name. The extraction process (function name) 115A will be described later with reference to FIG. 6.

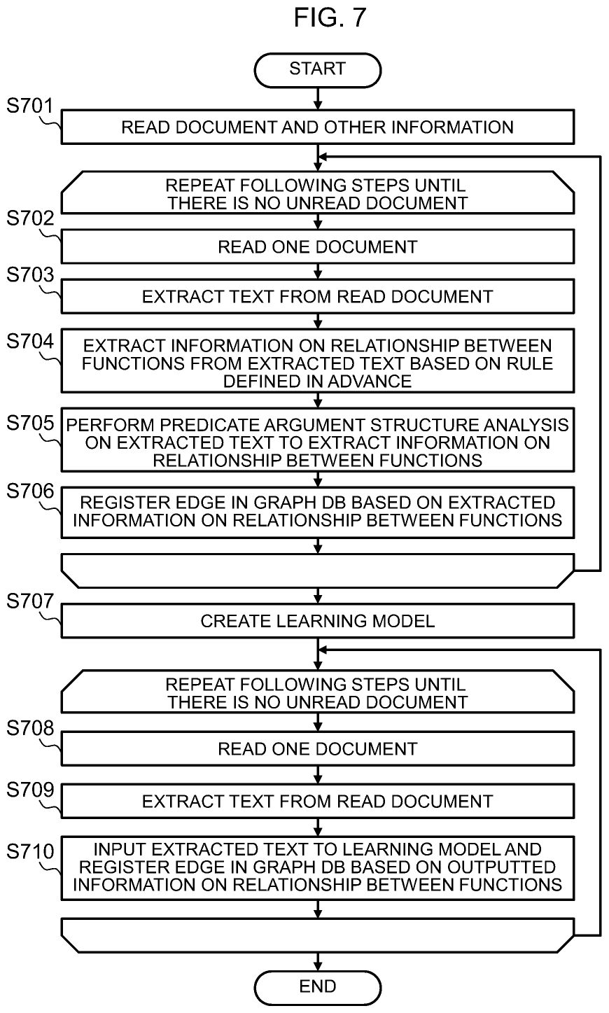

An image 220 is an image showing the result of the extraction process (function—function) 115B. In the extraction process (function—function) 115B, the server device 110, for example, reads the document and other information 140, extracts the relationship between the functions (function names) from the read document and other information 140, and registers relationship information representing the extracted relationship between the functions in the graph information 121. The image 220 shows an example in which a relationship 221 between the function A211 and the function B212 and a relationship 222 between the function B212 and the function C213 have been extracted as the relationship between the functions. The extraction process (function—function) 115B will be described later with reference to FIG. 7.

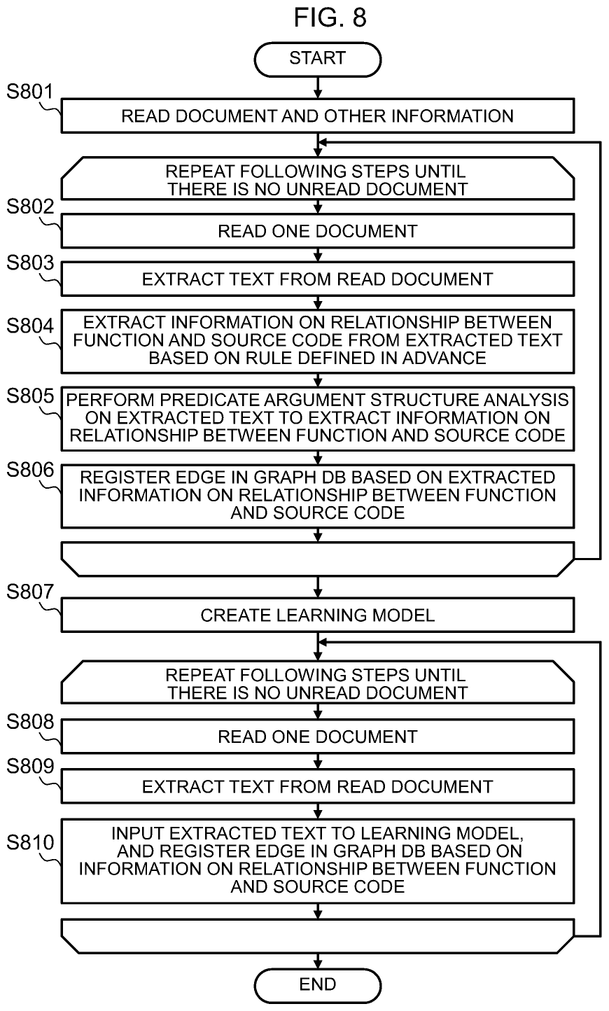

An image 230 is an image showing the result of the extraction process (function—source code) 115C. In the extraction process (function—source code) 115C, the server device 110, for example, reads the document and other information 140, extracts the relationship between a function and a source code from the read document and other information 140, and registers relationship information representing the extracted relationship in the graph information 121. The image 230 shows an example in which a relationship 232 between the function A211 and a source code A231, a relationship 234 between the function B212 and a source code B233, a relationship 235 between the function b214 and a source code B233, and a relationship 237 between the function b214 and a source code D236 have been extracted as the relationship between a function and a source code. To make an additional remark, in the extraction process (function—source code) 115C, it is preferable that the relationships between all functions and source codes are extracted, but there are relationships that are not extracted, such as the relationship between the function C213 and a source code C238, for example, because the document and other information 140 has not been updated. The extraction process (function—source code) 115C will be described later with reference to FIG. 8.

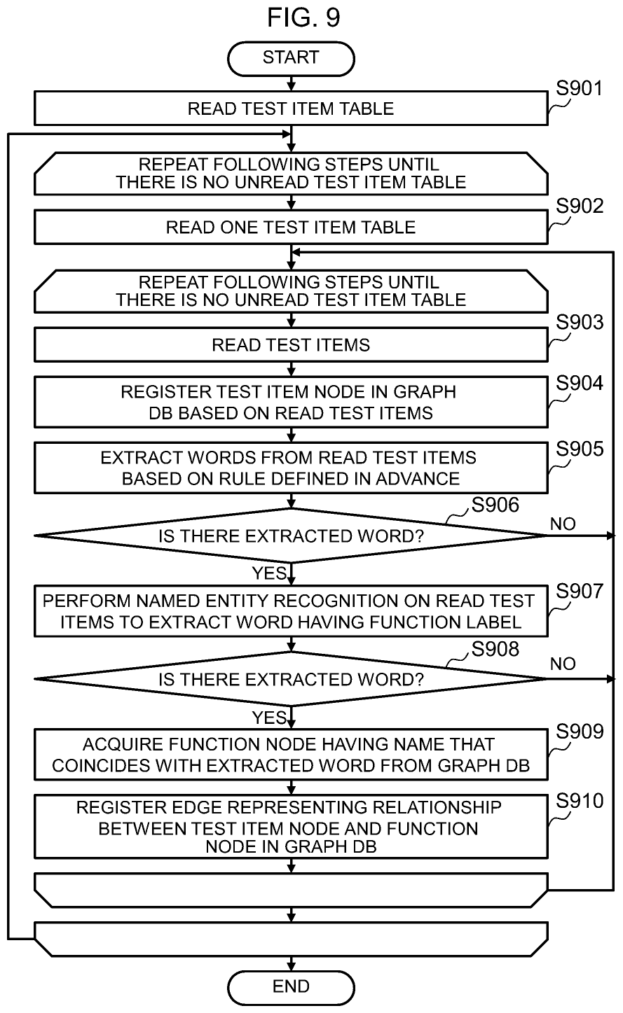

An image 240 is an image showing the result of the extraction process (function—test item) 115D. In the extraction process (function—test item) 115D, the server device 110, for example, reads the document and other information 140, extracts the relationship between a function and a test item from the read document and other information 140, and registers relationship information representing the extracted relationship in the graph information 121. The image 240 shows an example in which a relationship 242 between the function A211 and a test item A241, a relationship 244 between the function B212 and a test item B243, and a relationship 246 between the function C213 and a test item C245 have been extracted as the relationship between a functions and a test items. The extraction process (function—test item) 115D will be described later with reference to FIG. 9.

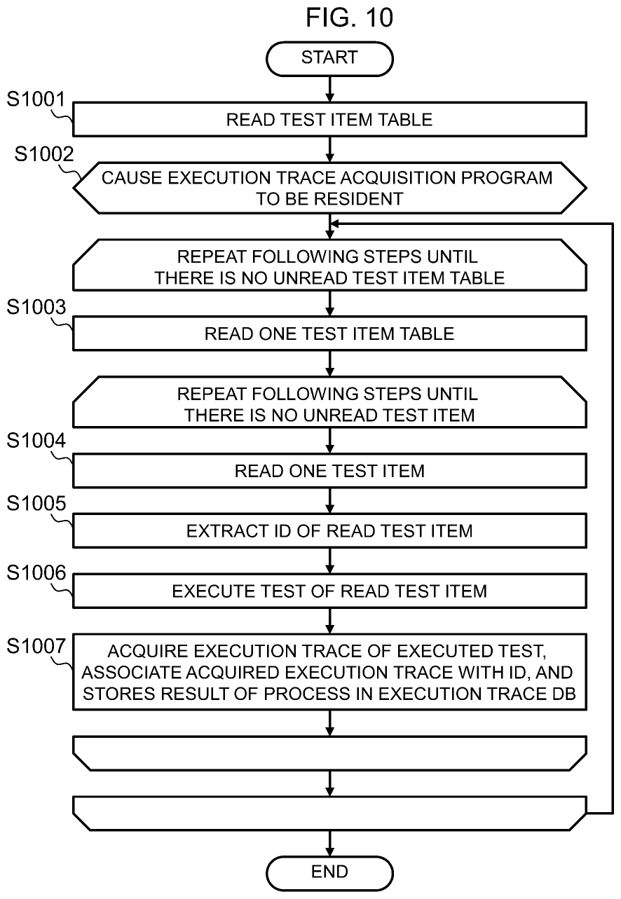

An image 250 is an image showing the result of the execution trace acquisition process 133A. In the execution trace acquisition process 133A, the test execution system 130, for example, reads the test item table 148, executes a test for each test item based on the read test item table 148, and registers an execution trace 251 showing the result of the execution in the execution trace information 122. The execution trace acquisition process 133A will be described later with reference to FIG. 10.

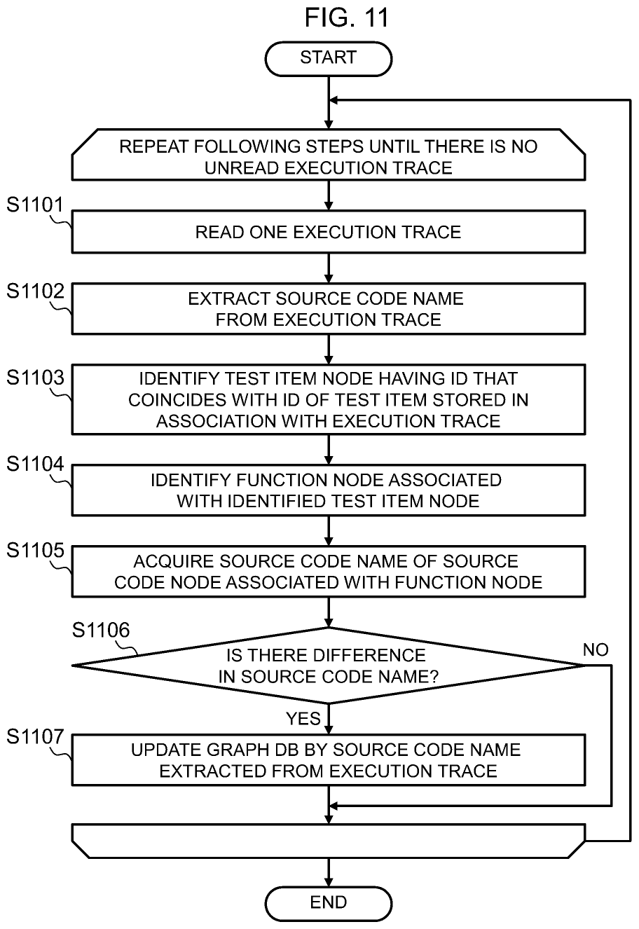

An image 260 is an image showing the result of the execution trace analysis process 116A. In the execution trace analysis process 116A, the server device 110, for example, reads the execution trace 251, and identifies the source code 146 of the program having run in the test of the test item. The execution trace analysis process 116A will be described later with reference to FIG. 11.

An image 270 is an image showing the result of the relationship correction process 116B. In the relationship correction process 116B, the server device 110, for example, extracts the relationship between a function and a source code based on the result of the execution trace analysis process 116A, and registers relationship information representing the extracted relationship in the graph information 121. The image 270 shows an example in which a relationship 271 between the function C213 and the source code C238 and a relationship 272 between the function B212 and a source code D236 have been extracted as the relationship between a function and a source code. To make an additional remark, in the relationship correction process 116B, relationships that are not extracted in the extraction process (function—source code) 115C are complemented based on the actual operation of the software. The relationship correction process 116B will be described later with reference to FIG. 11.

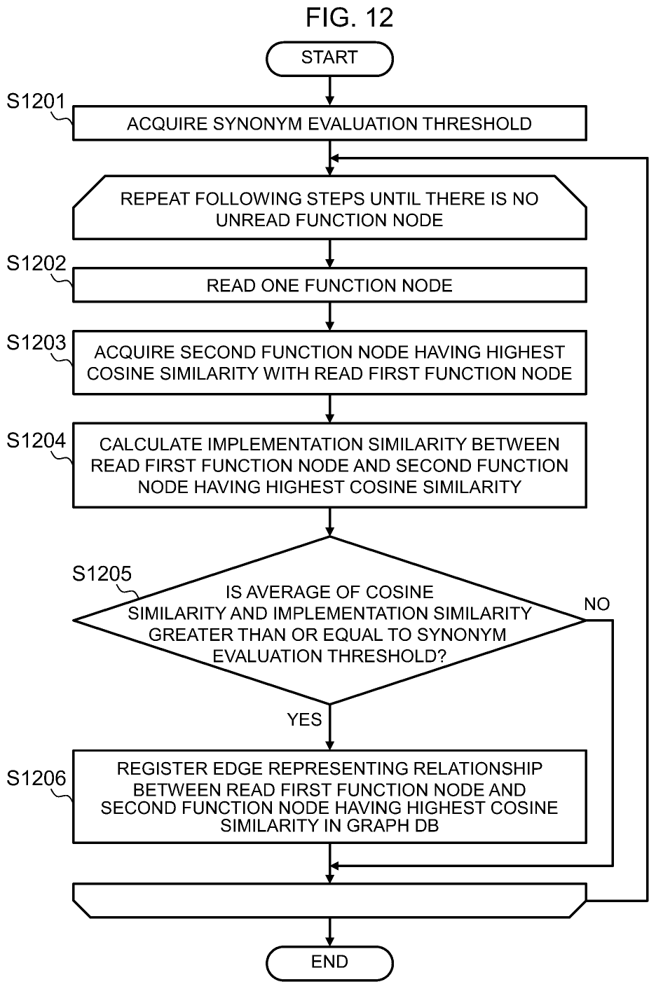

An image 280 is an image showing the result of the function name similarity evaluation process 117A. In the function name similarity evaluation process 117A, the server device 110, for example, calculates the similarity between the function names (functions) extracted in the extraction process (function name) 115A, and registers in the graph information 121 relationship information representing the relationship between functions the calculated similarity between which exceeds a threshold. The image 280 shows an example in which a relationship 281 between the functions B212 and b214 has been registered as the relationship between functions. The function name similarity evaluation process 117A will be described later with reference to FIG. 12.

FIG. 3 shows an example of the test item table 148.

The test item table 148 includes one or more test items 300. The test items 300 each include information on an ID 301, a category 302, a test overview 303, test details 304, a test procedure and conditions 305, and an expected result 306.

The ID 301 stores information that identifies the test item 300. The category 302 stores information that classifies the functions of the software by which the tests of the test item 300 are performed. For example, the category 302 stores a “function” when the test of the test item 300 is a test that checks a function of the software, stores “performance” when the test of the test item 300 is a test that checks performance of the software, and stores “security” when the test of the test item 300 is a test that checks security of the software, is stored. The test overview 303 stores information represents the overview of the test item 300. The test details 304 store information represents the details of the test item 300. The test procedure and conditions 305 store information representing the procedure and/or conditions of the test of the test item 300. The expected result 306 stores information representing a result expected when the test of the test item 300 is performed.

The test item table 148 shown in FIG. 3 is an example of test information, and may not contain the test overview 303 or other factors or may contain other information.

FIG. 4 shows an example of the graph information 121 (graph DB 420 including node information 400 and edge information 410).

In the following description, the node where the type of the document and other information 140 is a “function specification sheet” may be referred to as a function specification sheet node 401, the node where the type of the document and other information 140 is a “detailed design sheet” may be referred to as a detailed design sheet node 402, the node where the type of the document and other information 140 is a “source code change history” may be referred to as a source code change history node 403, the node where the type of the document and other information 140 is a “test item table” may be referred to as a test item table node 404, and the node where the type of the document and other information 140 is a “manual” may be referred to as an operation manual node 405. A node where the type of a word extracted from the document and other information 140 is a “function” may be referred to as a function node 406, a node where the type of the document and other information 140 is a “source code” may be referred to as a source code node 407, and a node where the type of a text extracted from the document and other information 140 is a “test item” may be referred to as a test item node 408.

The function specification sheet node 401, he detailed design sheet node 402, the source code change history node 403, the test item table node 404, the operation manual node 405, and the source code node 407, which are each the node information 400, contains identification information (ID) that identifies the node, information representing the name of the document and other information 140 (document name), and storage destination information (document URL (uniform resource locator)) representing the destination to which the document and other information 140 is stored. The function node 406, which is the node information 400, contains the identification information (ID) that identifies the node, information representing the name of the function (function name), and information representing the function name expressed in a vector space (distributed representation). The test item node 408, which is the node information 400, contains part or entirety of information on the test item 300 (ID 301, category 302, test overview 303, test details 304, test procedure and conditions 305, and expected result 306).

The edge information 410 contains identification information (ID) that identifies an edge representing the relationship between nodes, identification information (from) that identifies the node from which the edge starts, and identification information (to) that identifies the node to which the edge is coupled.

FIG. 5 shows an example of the execution trace information 122 (execution trace table 500).

The execution trace table 500 stores an execution trace for each test item 300. More specifically, the execution trace table 500 stores a record that associates an ID 501 with information on execution trace 502.

The ID 501 stores identification information (ID) that identifies the test item 300. The execution trace 502 stores information representing the content of actions (execution trace) performed when the test of the test item 300 is performed. For example, the execution trace 502 contains the names of executed source codes, the executed lines of the source codes, the contents of the lines of the source codes (such as function name, content of process, and comment), and other factors in the order of execution.

FIG. 6 shows an example of the extraction process (function name) 115A. In the extraction process (function name) 115A, the server device 110 extracts a function name from the document and other information 140, by using rule-based text extraction and/or named entity recognition, and stores the node information on the function of the extracted function name in the graph information 121. More specific contents will be described below.

In S601, the server device 110 reads the document and other information 140. For example, the server device 110 reads at least one of the following documents: the operation manual 143; the function specification sheet 144; the source code change history 145; the source code 146; the detailed design sheet 147; and the test item table 148. The server device 110 subsequently repeats the processes in steps S602 to S610 until there is no unread document, and when there is no unread document, the server device 110 terminates the extraction process (function name) 115A.

In S602, the server device 110 reads one of the unread documents.

In S603, in accordance with the type of the document read in S602, the server device 110 registers the node information 400 on the node of the type in the graph DB 420. For example, when the document read in S602 is the function specification sheet 144, the server device 110 generates the node information 400 on the function specification sheet node 401 and registers the node information 400 in the graph DB 420. To make an additional remark, in S603, the detailed design sheet node 402, the source code change history node 403, the test item table node 404, the operation manual node 405, and the source code node 407, which are each the node information 400, are also generated and registered in the graph DB 420.

In S604, the server device 110 extracts a text from the document read in S602.

In S605, the server device 110 extracts words from the text extracted in S604 based on a first rule defined in advance. The first rule is, for example, extracting an XX function when the text contains the “XX function”, extracting XX when the text contains “XX is the function for YY”, or extracting XX when the text contains “this function is called XX”. Since existing software includes software for the financial industry, software for the distribution industry, and software for other industries, and different domains (industries, for example) have different ways of document writing, so that the first rule may be a domain-specific rule.

In S606, the server device 110 evaluates whether or not there is a word extracted as a function. When the server device 110 determines that there is a word extracted as a function, the process in S606 transitions to the process in S607, whereas when the server device 110 determines that there is no word extracted as a function, the process in S606 transitions to the process in S602.

In S607, the server device 110 performs named entity recognition on the text extracted in S604 to extract a word having a function label. In this process, the server device 110, for example, performs fine-tuning based on the word extracted in S605 to perform the named entity recognition. The named entity recognition can be performed by using a known technology, such as bidirectional long short-term memory (BiLSTM), conditional random fields (CRF), and bidirectional encoder representations from transformers (BERT).

In S608, the server device 110 evaluates whether or not there is a word extracted as a function. When the server device 110 determines that there is a word extracted as a function, the process in S608 transitions to the process in S609, whereas when the server device 110 determines that there is no word extracted as a function, the process in S608 transitions to the process in S602.

In S609, the server device 110 acquires distributed representation for the word extracted in S605 or S607. For example, to compare the similarity between the extracted words, the server device 110 generates a vector (high-dimensional vector, such as 100-or 500-dimensional vector) representing the extracted words.

In S610, the server device 110 registers the node information 400 on the function node 406 in the graph DB 420 based on the words extracted in S605 and S607 and the distributed representation of the words. For example, the server device 110 generates the node information 400 on the function node 406 containing the extracted words (function names) and the acquired distributed representation, and registers the node information 400 in the graph DB 420. In this process, the server device 110 may, for example, register in the graph DB 420 the edge information 410 on the edge showing the relationship between the registered function node 406 and the node of the document read in S602.

The extraction process (function name) 115A is not limited to the content described above. For example, in place of S605 to S608, the server device 110 may extract a word based on the first rule defined in advance from the text extracted in S604, and give the word a function label representing that the word is a function name. In this case, the server device 110 performs the named entity recognition on the text having a word to which a function label has been given to extract the word having a function label. In the named entity recognition, the server device 110 learns what context a word to which a function label has been given is used in, and when a word to which no function label has been given is used in the same context, the server device 110 presumes that the word is a function name.

FIG. 7 shows an example of the extraction process (function - function) 115B. In the extraction process (function—function) 115B, the server device 110 extracts information representing the relationship between functions from the document and other information 140 through rule-based extraction based on the structure of the document, predicate argument structure analysis, and/or machine learning, and stores the extracted information in the graph information 121. More specific contents will be described below.

In S701, the server device 110 reads the document and other information 140. For example, the server device 110 reads at least one of the following documents: the operation manual 143; the function specification sheet 144; the source code change history 145; the source code 146; the detailed design sheet 147; and the test item table 148. The server device 110 subsequently repeats the processes in steps S702 to S706 until there is no unread document, and when there is no unread document, the server device 110 causes the process to transition to the process in S707.

In S702, the server device 110 reads one of the unread documents.

In S703, the server device 110 extracts a text from the documents read in S702.

In S704, the server device 110 extracts information on the relationship between functions based on a second rule defined in advance from the texts extracted in S703. The second rule is, for example, extracting the relation of XX with YY and the relation of XX with ZZ when the text contains “an XX function contains the following: YY; and ZZ”. Note that the second rule may be a domain-specific rule. For example, when there is a relation of a function A (function node 406, which is coupling source) to a function B (function node 406, which is coupling destination), the information on the relationship between functions contains information representing the start and end positions where the function A appears in the text and the start and end positions where the function B appears in the text.

In S705, the server device 110 performs predicate argument structure analysis on the text extracted in S703 to extract the information on the relationship between functions. In the predicate argument structure analysis, the server device 110 analyzes, for example, the relationship between the subject, the object, and the predicate. For example, when “the function A uses function B to xx”, the server device 110 extracts the presence of the relationship of the “function A” with the “function B”. The predicate argument structure analysis can be a known technology, such as recurrent neural network (RNN).

In S706, the server device 110 registers in the graph DB 420 the edge information 410 on the edge based on the information on the relationship between functions extracted in each of S704 and S705. For example, the server device 110 generates the edge information 410 containing the ID of the function node 406, which is the coupling source, and the ID of the function node 406, which is the coupling destination, and registers the edge information 410 in the graph DB 420. The server device 110 stores the text extracted in S703 and information on the relationships between functions extracted in S704 and S705 in association with the edge information 410.

In S707, the server device 110 creates a learning model that can infer the relationship between functions. For example, the server device 110 acquires the text registered in S706 and the information on the relationship between functions, and performs machine learning by using the text with which the information on the relationship between functions is associated as input data to create the learning model. The server device 110 subsequently repeats the processes in steps S708 to S710 until there is no unread document, and when there is no unread document, the server device 110 terminates the extraction process (function—function) 115B.

In S708, the server device 110 reads one of the unread documents.

In S709, the server device 110 extracts a text from the document read in S708.

In S710, the server device 110 inputs the text extracted in S709 to the learning model and registers in the graph DB 420 the edge information 410 on the edge based on the outputted information on the relationship between functions.

The extraction process (function—function) 115B is not limited to the content described above. For example, one or two of the processes in S704, S705, and S707 to S710 may not be carried out.

FIG. 8 shows an example of the extraction process (function—source code) 115C. In the extraction process (function—source code) 115C, the server device 110 extracts information representing the relationship between the function and the source code 146 from source-code-related document 141 through rule-based extraction based on the document structure, predicate argument structure analysis, and/or machine learning, and stores the extracted information in the graph information 121. More specific contents will be described below.

In S801, the server device 110 reads the document and other information 140, more specifically, the source-code-related document 141. For example, the server device 110 reads at least one of the following documents: the source code change history 145; the source code 146; and the detailed design sheet 147. The server device 110 subsequently repeats the processes in S802 to S806 until there is no unread document, and when there is no unread document, the server device 110 causes the process to transition to the process in S807.

In S802, the server device 110 reads one of the unread documents.

In S803, the server device 110 extracts a text from the document read in S802.

In S804, the server device 110 extracts information on the relationship between the function and the source code based on a third rule defined in advance from the text extracted in S803. The third rule is, for example, extracting a table of the source code 146 to be corrected when there is a description “correct the XX function” in the detailed design sheet 147, or extracting a table of contents, such as “Correct source code A”. Note that the third rule may be a domain-specific rule. For example, when there is a relation of the function A (function node 406, which is coupling source) with the source code A (source code node 407, which is coupling destination), the information on the relationship between the function and the source code contains information representing the start and end positions where the function A appears in the text and the start and end positions where the source code A appears in the text.

In S805, the server device 110 performs predicate argument structure analysis on the text extracted in S803 to extract the information on the relationship between the function and the source code.

In S806, the server device 110 registers in the graph DB 420 the edge information 410 on the edge based on the information on the relationship between the function and the source code extracted in each of S804 and S805. For example, the server device 110 generates the edge information 410 containing the ID of the function node 406, which is the coupling source, and the ID of the source code node 407, which is the coupling destination, and registers the edge information 410 in the graph DB 420. The server device 110 stores the text extracted in S803 and the information on the relationship between the function and the source code extracted in S804 and S805 in association with the edge information 410.

In S807, the server device 110 creates a learning model that can infer the relationship between the function and the source code. For example, the server device 110 acquires the text registered in S806 and the information on the relationship between the function and the source code, and performs machine learning by using the text with which the information on the relationship between the function and the source code has been associated as input data to create a learning model. The server device 110 subsequently repeats the processes in steps S808 to S810 until there is no unread document, and when there is no unread document, the server device 110 terminates the extraction process (function—source code) 115C.

In S808, the server device 110 reads one of the unread documents.

In S809, the server device 110 extracts a text from the document read in S808.

In S810, the server device 110 inputs the text extracted in S809 to the learning model and registers in the graph DB 420 the edge information 410 on the edge based on the outputted information on the relationship between the function and the source code.

The extraction process (function—source code) 115C is not limited to the content described above. For example, based on the outputted information on the relationship between the function and the source code, the server device 110 may identify another source code 146 associated with the outputted function, and register in the graph DB 420 the edge information 410 on the edge representing the relationship between the identified other source code 146 and the outputted source codes 146. For example, one or two of the processes in S804, S805, and S807 to S810 may not be carried out.

FIG. 9 shows an example of the extraction process (function—test item) 115D. In the extraction process (function—test item) 115D, from the description of the name and/or the test content of each test item 300, the function name of the test target function of the test item 300 is extracted through rule-based text extraction and/or named entity recognition, and information representing the relationship between the extracted function name and the test item 300 is stored in the graph information 121. More specific contents will be described below.

In S901, the server device 110 reads the test-related document 142. For example, the server device 110 reads the test item table 148. The server device 110 subsequently repeats the processes in steps S902 to S910 until there is no unread test item table 148, and when there is no unread test item table 148, the server device 110 terminates the extraction process (function—test item) 115D.

In S902, the server device 110 reads one of the unread test item tables 148. The server device 110 subsequently repeats the processes in steps S903 to S910 until there is no unread test item 300, and when there is no unread test item 300, the server device 110 causes the process to transition to the process in S902.

In S903, the server device 110 reads the unread test items 300 from the test item table 148 read in S902.

In S904, the server device 110 registers in the graph DB 420 the node information 400 on the test item node 408 based on the test items 300 read in S903. For example, the server device 110 generates the node information 400 on the test item node 408 from the information on the ID 301, the category 302, the test overview 303, the test details 304, the test procedure and conditions 305, and the expected result 306 contained in the test items 300, and registers the node information 400 in the graph DB 420. In this process, the server device 110 may, for example, register in the graph DB 420 the edge information 410 on the edge showing the relationship between the registered test item node 408 and the test item table node 404 of the node test item table 148 read in S902.

In S905, the server device 110 extracts words based on the first rule defined in advance from the test items 300 read in S903.

In S906, the server device 110 evaluates whether or not there is a word extracted as a function. When the server device 110 determines that there is a word extracted as a function, the server device 110 cause the process in S906 to transition to the process in S907, whereas when the server device 110 determines that there is no word extracted as a function, the server device 110 cause the process in S906 to transition to the process in S903.

In S907, the server device 110 performs named entity recognition on the test items 300 read in S903 to extract a word having a function label.

In S908, the server device 110 evaluates whether or not there is a word extracted as a function. When the server device 110 determines that there is a word extracted as a function, the server device 110 cause the process in S908 to transition to the process in S909, whereas when the server device 110 determines that there is no word extracted as a function, the server device 110 cause the process in S908 to transition to the process in S903.

In S909, the server device 110 acquires from the graph DB 420 the node information 400 on the function node 406 having a name that coincides with the word extracted in S905 or S907.

In S910, the server device 110 registers in the graph DB 420 the edge information 410 on the edge representing the relationship between the test item node 408 registered in S904 and the function node 406 of the node information 400 acquired in S909.

FIG. 10 shows an example of the execution trace acquisition process 133A. In the execution trace acquisition process 133A, the test execution system 130 executes a regression test based on the test item table in response, for example, to software build. In the execution trace acquisition process 133A, the test execution system 130 acquires the execution trace of each test item 300 by using an execution trace acquisition program that is resident in advance and acquires the execution trace during test execution. More specific contents will be described below.

In S1001, the test execution system 130 reads the test item tables 148.

In S1002, the test execution system 130 causes the execution trace acquisition program to be resident therein. The test execution system 130 subsequently repeats the processes in steps S1003 to S1007 until there is no unread test item table 148, and when there is no unread test item table 148, the test execution system 130 terminates the execution trace acquisition process 133A.

In S1003, the test execution system 130 reads one of the unread test item tables 148. The test execution system 130 subsequently repeats the processes in S1004 to S1007 until there is no unread test item 300, and when there is no unread test item 300, the test execution system 130 causes the process to transition to the process in S1004.

In S1004, the test execution system 130 reads one unread test item 300 from the test item table 148 read in S1003.

In S1005, the test execution system 130 extracts the ID of the test item 300 read in S1004.

In S1006, the test execution system 130 executes the test of the test item 300 read in S1004.

In S1007, the test execution system 130 acquires the execution trace of the test executed in S1006, associates the acquired execution trace with the ID of the test item 300, and stores the result of the process in S1007 in an execution trace DB (execution trace table 500, for example).

FIG. 11 shows an example of a complementation process (execution trace analysis process 116A and relationship correction process 116B). In the execution trace analysis process 116A, the server device 110 analyzes the execution trace of the test to extract the source code 146 (such as class name and file name) that realizes the function to be tested, and registers information representing the relationship between the extracted source code 146 and the function in the graph information 121. In this process, the server device 110 adds, if any, new information that is not in the graph information 121, and when information on the same function has already been stored in the graph information 121 and there is a difference in the information representing the relationship with the source code 146, the server device 110 corrects the information in the graph information 121.

More specifically, the server device 110 repeats the processes S1101 to S1107 until there is no unread execution trace in the execution trace DB, and when there is no unread execution trace, the server device 110 terminates the execution trace analysis process 116A.

In S1101, the server device 110 reads one of the unread execution traces.

In S1102, the server device 110 extracts the source code name from the execution trace read in S1101.

In S1103, the server device 110 refers to the node information 400 in the graph DB 420 and identifies the test item node 408 having an ID that coincides with the ID of the test item 300 stored in association with the execution trace.

In S1104, the server device 110 refers to the edge information 410 in the graph DB 420 and identifies the function node 406 associated with the test item node 408 identified in S1103.

In S1105, the server device 110 acquires from the graph DB 420 the node information 400 (source code name) of the source code node 407 associated with the function node 406 identified in S1104.

In S1106, the server device 110 evaluates whether or not there is a difference between the source code name extracted from the execution trace in S1102 and the source code name acquired in S1105. When the server device 110 determines that there is a difference, the server device 110 causes the process in S1106 to transition to the process in S1107, whereas when the server device 110 determines that there is no difference, the server device 110 cause the process in S1106 to transition to the process in S1101.

In S1107, the server device 110 stores in the graph DB 420 the source code name of the source code node 407 associated with the function node 406 identified in S1104 in such a way that the source code name is updated by the source code name extracted from the execution trace. For example, let “A” be the source code name extracted from the execution trace in S1102, 407 “A” be the source code node having the source code name “A”, “B” be the source code name acquired in S1105, and 407 “B” be the source code node having the source code name “B”. In S1107, the server device 110 deletes the edge information 410 on the edge between the function node 406 and the source code node 407 “B”, and generates the edge information 410 on the edge between the function node 406 and source code node 407 “A”.

The execution trace analysis process 116A is not limited to the content described above. For example, when the server device 110 does not carry out the extraction process (function—source code) 115C in FIG. 8, the server device 110 may register the source code name extracted from the execution trace in the graph DB without performing the evaluation in S1106.

FIG. 12 shows an example of the function name similarity evaluation process 117A. In the function name similarity evaluation process 117A, the server device 110 calculates similarity between function names by using an edit distance, distributed representation, or any other factor. In this process, the server device 110 further calculates implementation similarity, takes into account the function name similarity and the execution trace similarity, and determines a pair of words within a tolerance threshold specified in advance to be a synonym. When the server device 110 determines that the words are synonymous, the server device 110 corrects the graph information 121. More specific contents will be described below.

In S1201, the server device 110 acquires a synonym evaluation threshold. The server device 110 subsequently repeats S1202 to S1206 until there is no unread node information 400 on the function node 406, and when there is no unread node information 400 on the function node 406, the server device 110 terminates the function name similarity evaluation process 117A.

In S1202, the server device 110 reads the node information 400 on one of the unread function nodes 406 from the graph DB 420.

In S1203, the server device 110 calculates the Cosine similarity between the distributed representation of the first function node 406 read in S1202 and the distributed representation of each of the other function nodes 406 in the graph DB 420 to acquire a second function node 406 having the highest Cosine similarity.

In S1204, the server device 110 calculates the implementation similarity (X/Y) between the first function node 406 read in S1202 and the second function node 406 acquired in S1203 and having the highest cosine similarity. In the calculation, X is the sum of the number of first source code names and second source code names that coincide with each other, the first source code names being those of the source code node 407 associated with the read first function node 406 and the second source code names being those of the source code node 407 associated with the acquired second function node 406. In the calculation, Y is the sum of the number of unique source code names in the first source code names and the second source code names.

In S1205, the server device 110 evaluates whether or not the average of the highest cosine similarity calculated in S1203 and the implementation similarity calculated in S1204 is equal to or larger than the synonym evaluation threshold. When the server device 110 determines that the average is equal to or larger than the synonym evaluation threshold, the server device 110 cause the process in S1205 to transition to the process in S1206, whereas when the server device 110 determines that the average is not equal to or larger than the synonym evaluation threshold, the server device 110 cause the process in S1205 to transition to the process in S1202.

In S1206, the server device 110 registers in the graph DB 420 the edge information 410 on the edge representing the relationship between the first function node 406 read in S1202 and the second function node 406 acquired in S1203 and having the highest cosine similarity. For example, the server device 110 generates the edge information 410 representing the relation of the first function node 406 with the second function node 406 and the edge information 410 representing the relation of the second function node 406 with the first function node 406 and registers the generated edge information 410 in the graph DB 420.

The function name similarity evaluation process 117A is not limited to the content described above. For example, in the function name similarity evaluation process 117A, the similarity between functions may be evaluated by using either the cosine similarity or the implementation similarity.

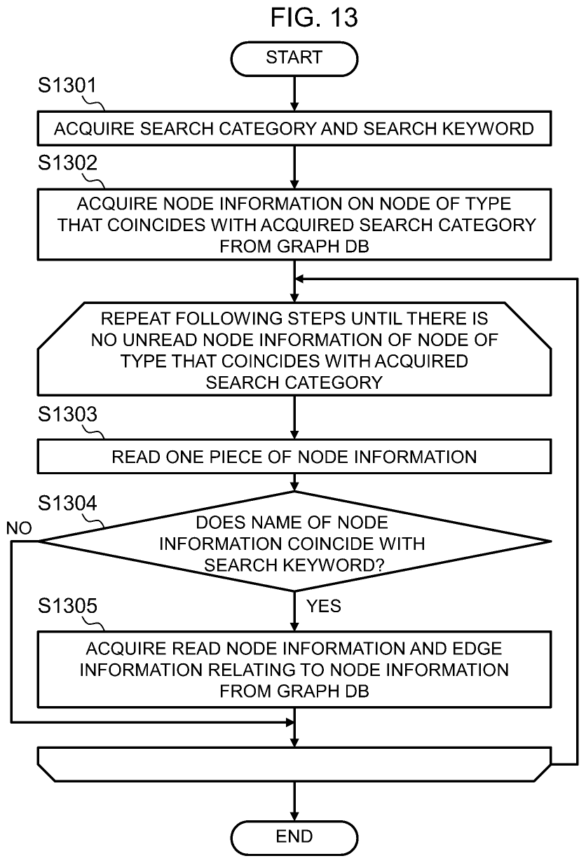

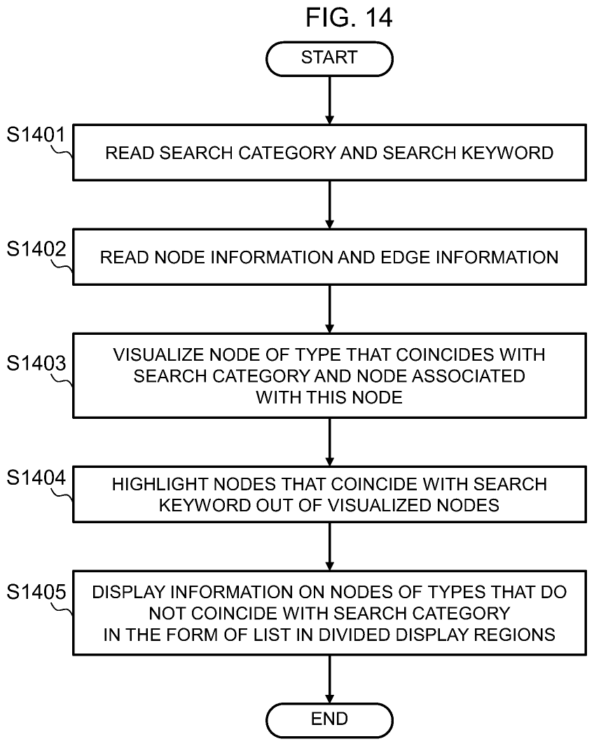

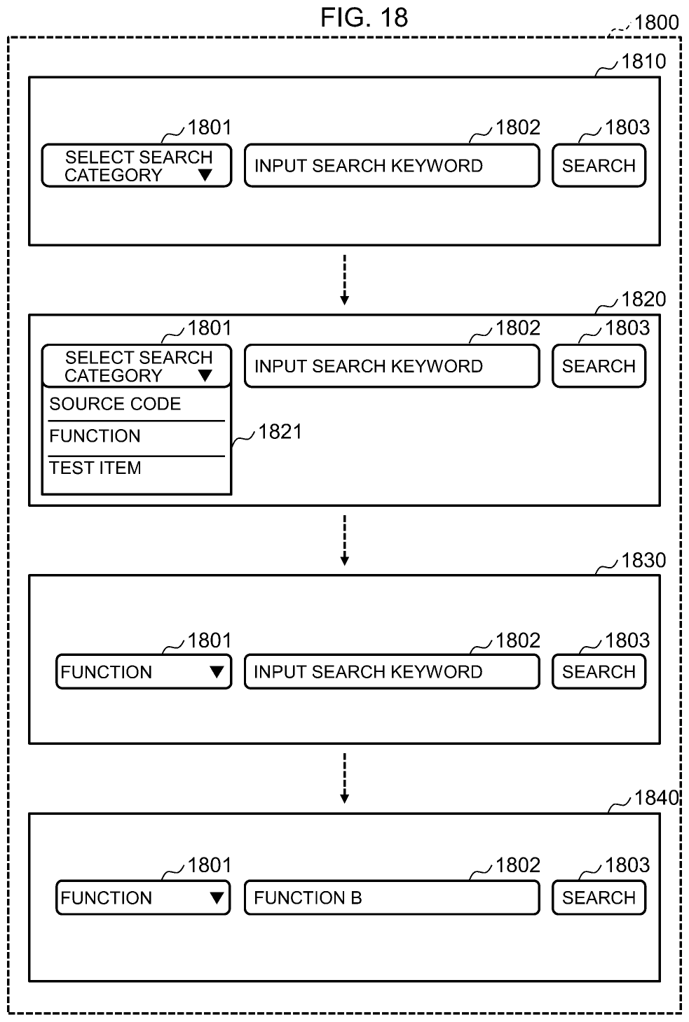

A search process carried out when the user performs a search will next be described with reference to FIGS. 13 and 14. The search process will be described by using the screens shown in FIGS. 18 to 23 as appropriate.

FIG. 13 shows an example of the search process 118A. In the search process 118A, the server device 110 searches for the graph information 121 based on a keyword inputted through the user's operation of the input device 113 and extracts information relating to the keyword.

In S1301, the server device 110 acquires a search category and a search keyword inputted by the user via a predetermined screen (screen 1800 shown in FIG. 18, for example).

In S1302, the server device 110 acquires from the graph DB 420 the node information 400 on a node of the type that coincides with the search category acquired in S1301. The server device 110 subsequently repeats S1303 to S1305 until there is no unread node information 400 on the node of the type that coincides with the acquired search category, and when there is no unread node information 400, the server device 110 terminates the search process 118A.

In S1303, the server device 110 reads one piece of unread node information 400 on a node of the type that coincides with the search category acquired in S1302.

In S1304, the server device 110 evaluates whether or not the name of the node information 400 read in S1303 coincides with the search keyword. When the server device 110 determines that the name of the node information 400 read in S1303 coincides with the search keyword, the server device 110 causes the process in S1304 to transition to the process in S1305, whereas when the server device 110 determines that the name of the node information 400 read in S1303 does not coincide with the search keyword, the server device 110 causes the process in S1304 to transition to the process in S1303.

In S1305, the server device 110 acquires the node information 400 read in S1303, the edge information 410 relating to the node having the node information 400, and the node information 400 on the node relating to the edge information 410 from the graph DB 420 as visualization information.

For example, when the node relationship shown in the image 280 is provided, and the “function” is inputted as the search category and the “function B” is inputted as the search keyword (hereinafter referred to as exemplary case) by the user, the server device 110 first acquires the node information 400 on the function node 406 “function B” from the graph DB. The server device 110 subsequently acquires from the graph DB 420 the edge information 410 containing the ID of the function node 406 “function B”, more specifically, the edge information 410 on each of the relationships 221, 222, 234, 244, 272, and 281. The server device 110 subsequently acquires from the graph DB420 the node information 400 on each of the following functions as the node information 400 relating to the acquired edge information 410: the function node 406 “function A”; the function node 406 “function C”; the source code node 407 “source code B”; the test item node 408 “test item B”; the source code node 407 “source code D”; and the function node 406 “function b”.

FIG. 14 shows an example of a display process 118B. In the display process 118B, the server device 110 presents the result of the search process 118A to the user in a graphical form (visualized in the form of a network, for example).

In S1401, the server device 110 reads the search category and the search keyword acquired in S1301.

In S1402, the server device 110 reads the visualized information (node information 400 and edge information 410) acquired in S1305.

In S1403, the server device 110 visualizes the node of the type that coincides with the search category and the node of this type associated with this node out of the visualized information acquired in S1305.

In the exemplary case, for example, the server device 110 couples the function node 406 “function B” to each of the function node 406 “function A” and the function node 406 “function C” associated with the function node 406 “function B” via an edge and displays the coupled functions in the shape of a network on the output device 114.

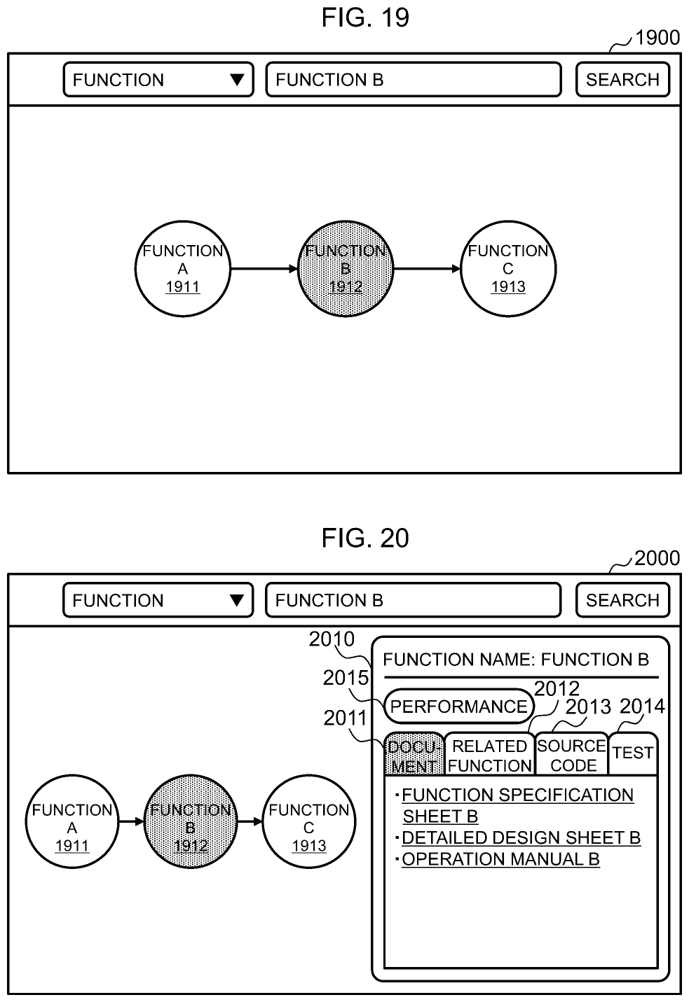

In S1404, the server device 110 highlights the nodes that coincide with the search keyword out of the visualized nodes. FIG. 19 shows an example of the screen after the process S1404 (result of search).

In S1405, the server device 110 lists the node information 400 on the nodes of types that do not coincide with the search category out of the visualized information acquired in S1305 in divided display areas corresponding to the types of the nodes. FIGS. 20 to 23 show examples of the screen after the process S1405 (result of search). The process in S1405 may be carried out when specific operation (clicking on node that coincides with search keyword, for example) is performed.

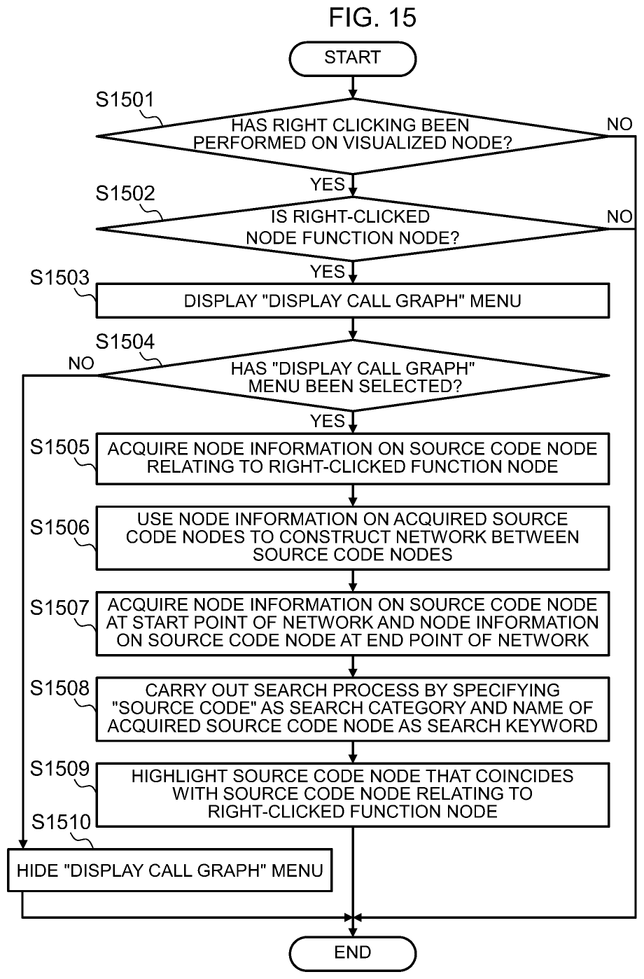

FIG. 15 shows an example of a call graph display process. The call graph display process is carried out at a predetermined timing (periodically, for example).

In S1501, the server device 110 evaluates whether or not right clicking is performed on a node visualized in the form of a network. When the server device 110 determines that right clicking has been performed, the server device 110 causes the process in S1501 to transition to the process in S1502, whereas when the server device 110 determines that right clicking has not been performed, the server device 110 terminates the call graph display process.

In S1502, the server device 110 evaluates whether or not the right-clicked node is the function node 406. When the server device 110 determines that the right-clicked node is the function node 406, the server device 110 causes the process in S1502 to transition to the process in S1503, whereas when the server device 110 determines that the right-clicked node is not the function node 406, the server device 110 terminates the call graph display process.

In S1503, the server device 110 displays a “display call graph” menu. FIG. 24 shows an example of the screen after the process S1503.

In S1504, the server device 110 evaluates whether or not the “display call graph” menu has been selected. When the server device 110 determines that the “display call graph” menu has been selected, the server device 110 causes the process in S1504 to transition to the process in S1505, whereas when the server device 110 determines that the “display call graph” menu has not been selected, the server device 110 causes the process in S1504 to transition to the process in S1510.

In S1505, the server device 110 acquires from the graph DB 420 the node information 400 on the source code node 407 associated with the right-clicked function node 406. For example, the server device 110 extracts from the graph DB 420 the edge information 410 containing the ID of the right-clicked function node 406, and evaluates whether or not any of the extracted pieces of edge information 410 contains the ID of the source code node 407. When right clicking is performed on the function node 406 “function B” in the exemplary case, the node information 400 on the source code node 407 “source code B” and the source code node 407 “source code D” is acquired.

In S1506, the server device 110 uses the node information 400 on the source code nodes 407 acquired in S1505 to acquire the edge information 410 between the source code nodes 407 from the graph DB 420 and constructs the network.

In S1507, the server device 110 acquires from the graph DB 420 the node information 400 on the source code node 407 at the start point of the constructed network and the node information 400 on the source code node 407 at the end point of the network.

In S1508, the server device 110 carries out the search process by specifying the “source code” as the search category and the source code name of the node information 400 acquired in S1507 as the search keyword. For example, when the server device 110 carries out the search process by specifying the source code node 407 “source code B” at the start point, the server device 110 acquires the node information 400 on the source code node 407 “source code B,” the edge information 410 relating to the node having the node information 400, and the node information 400 on the source code node 407 “source code A” relating to the edge information 410.

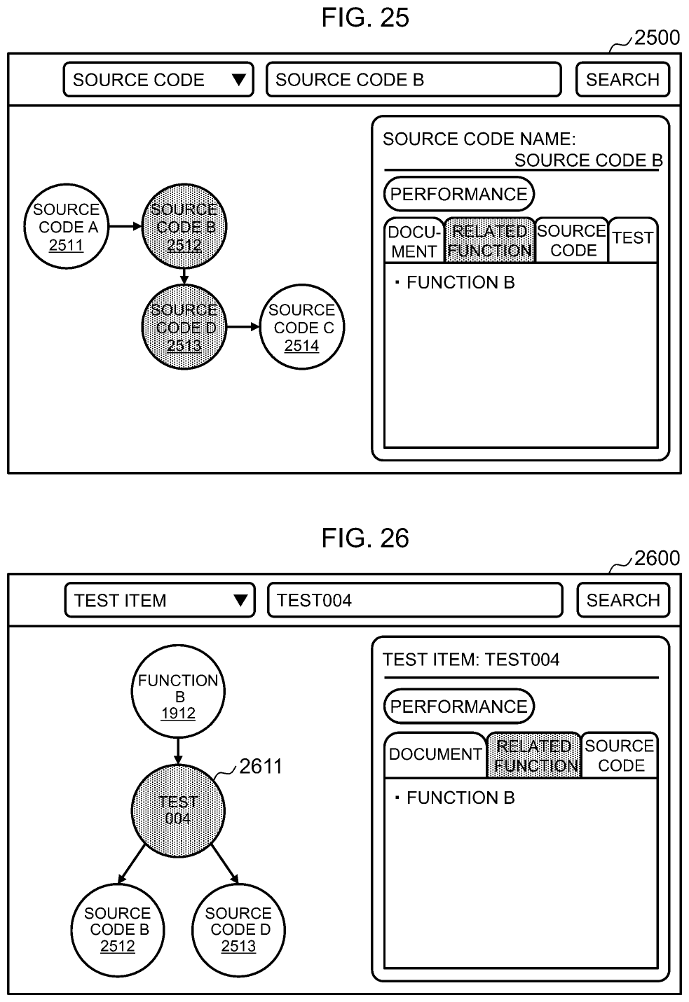

In S1509, the server device 110 visualizes the network constructed in S1506, the source code node 407 associated with the source code node 407 at the start point of the network acquired in S1508, and the source code node 407 associated with the source code node 407 at the end of the network, highlights the source code node 407 that coincides with the source code node 407 relating to the right-clicked function node 406, and terminates the call graph display process. FIG. 25 shows an example of the screen after the process S1509.

At S1510, the server device 110 hides the “display call graph” menu and terminates the call graph display process.

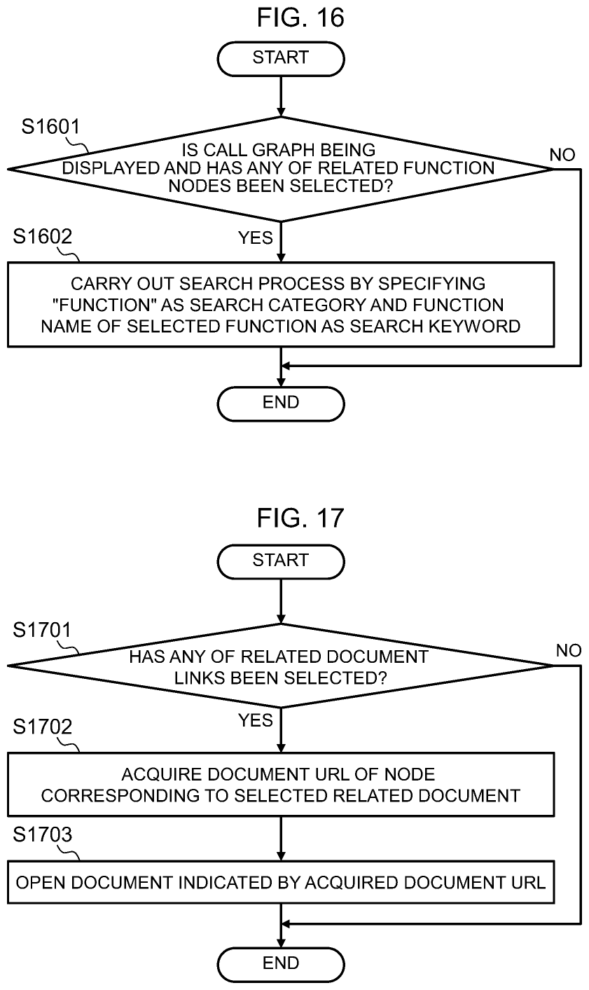

FIG. 16 shows an example of a related function search process. The related function search process is carried out at a predetermined timing (periodically, for example).

In S1601, the server device 110 evaluates whether or not the “display call graph” menu is being displayed and any of the function nodes 406 (related-function nodes) associated with the right-clicked function node 406 has been selected. When the server device 110 determines that the “display call graph” menu is being displayed and any of the related functions has been selected, the server device 110 causes the process in S1601 to transition to the process in S1602, whereas when the server device 110 determines that the “display call graph” menu is not being displayed or none of the related functions has been selected, the server device 110 terminates the related function search process.

In S1602, the server device 110 carries out the search process by specifying the “function” as the search category and the function name of the selected function node 406 as the search keyword.

FIG. 17 shows an example of a related document reference process. The related document reference process is carried out at a predetermined timing (periodically, for example).

In S1701, the server device 110 evaluates whether or not any of the links to the document and other information 140 (related document links) associated with the highlighted function node 406 has been selected. When the server device 110 determines that a related document link has been selected, the server device 110 causes the process in S1701 to transition to the process in S1702, whereas when the server device 110 determines that no related document link has been selected, the server device 110 terminates the related document reference process.

In S1702, the server device 110 acquires a document URL from the node information 400 on the node corresponding to the selected related document link.

In S1703, the server device 110 opens the document and other information 140 (file) indicated by the document URL acquired in S1702 and terminates the related document reference process.

FIG. 18 shows an example of a screen outputted by the server device 110 (screen 1800).

The screen 1800 includes a selection interface 1801, which allows selection of a search category (type of node), an input interface 1802, which allows input of a search keyword, and a search execution interface 1803, which allows execution of the search. The user selects a search category via the selection interface 1801, inputs a search keyword via the input interface 1802, and executes the search via the search execution interface 1803.

A screen 1810 is an initial screen of the screen 1800. A screen 1820 is an example of the screen that appears when the selection interface 1801 is clicked. The screen 1820 displays a search category list 1821, which includes one or more search categories. A screen 1830 is an example of the screen that appears when the search category “function” in the search category list 1821 is selected. A screen 1840 is an example of the screen that appears when the “function B” is inputted to the input interface 1802.

FIG. 19 shows an example of the screen outputted by the server device 110 (screen 1900).

The screen 1900 shows an example of a screen that shows the result of the search and appears when the “function” and the “function B” are specified as the search category and the search keyword, respectively, and the search execution interface 1803 is operated on the screen 1800. On the screen 1900, a node corresponding to the search category and the search keyword and nodes relating to the node are displayed, and the node corresponding to the search keyword is highlighted (displayed in emphasized form). The present example, in which the node corresponding to the search category and the search keyword is the function node B1912, indicates that the function node B1912 relates to the function node A1911 and the function node C1913, and the function node B1912 corresponding to the search keyword is highlighted.

FIG. 20 shows an example of the screen outputted by the server device 110 (screen 2000).

The screen 2000 shows an example of a screen that appears when the function node B1912 is selected (clicked) on the screen 1900. The screen 2000 displays a detailed screen 2010, where the user can view details of the selected function (selected function). The detailed screen 2010 includes a document tab 2011 for displaying the document and other information 140 relating to the selected function, a related function tab 2012 for displaying functions relating to the selected function, a source code tab 2013 for displaying the source codes 146 relating to the selected function, a test tab 2014 for displaying the test items 300 relating to the selected function, and a display area 2015, where non-functional requirements are displayed. In the present example, the state in which the document tab 2011 has been selected is shown, and a function specification sheet B, a detailed design sheet B, and an operation manual B are displayed as the document and other information 140 relating to the function node B1912, which is the selected function. The function specification sheet B, the detailed design sheet B, and the operation manual B have links which allows the user to refer to the document and other information 140.

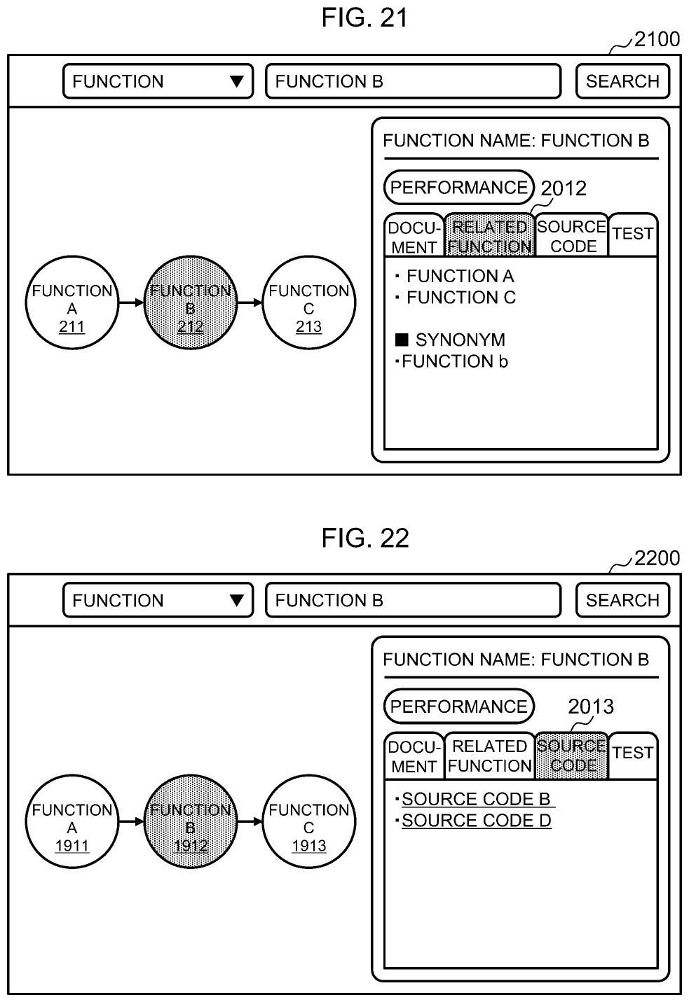

FIG. 21 shows an example of the screen outputted by the server device 110 (screen 2100).

The screen 2100 shows an example of the screen that appears when the related function tab 2012 is selected on the screen 2000. On the screen 2100, the functions A and C are displayed as the functions relating to the selected function, and the function b is displayed as a function similar to the selected function (synonym of selected function).

FIG. 22 shows an example of the screen outputted by the server device 110 (screen 2200).

The screen 2200 shows an example of the screen that appears when the source code tab 2013 is selected on the screen 2000. On the screen 2200, the source codes B and D are displayed as the source codes 146 relating to the selected function, and links that allow the user to refer to the source codes 146 are provided.

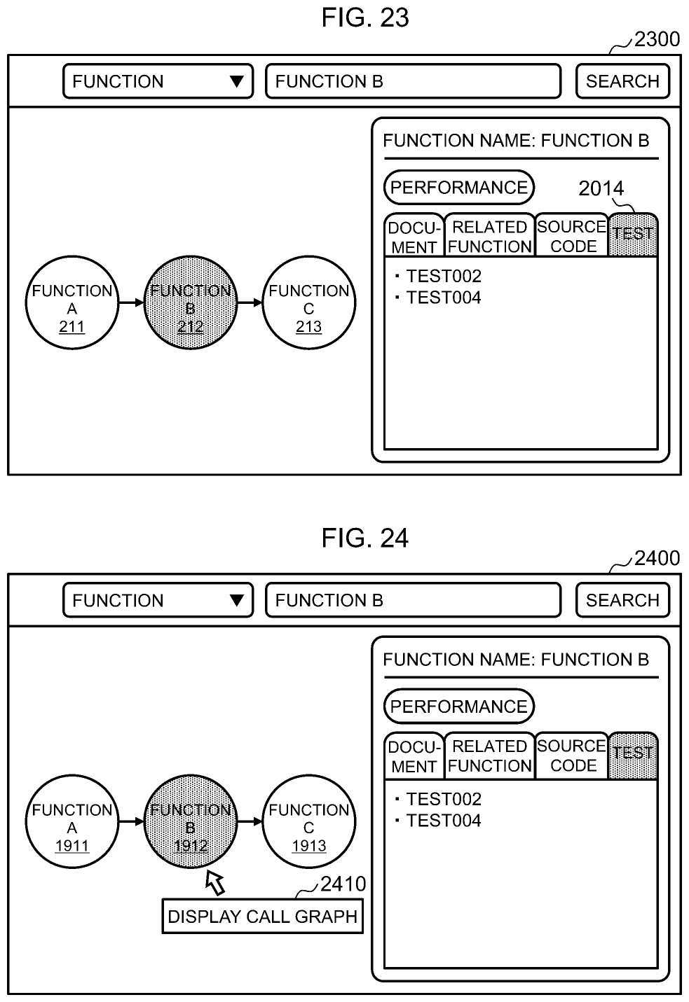

FIG. 23 shows an example of the screen outputted by the server device 110 (screen 2300).

The screen 2300 shows an example of the screen that appears when the test tab 2014 is selected on the screen 2000. On the screen 2300, TEST002 and TEST004 are displayed as the test items relating to the selected function.

FIG. 24 shows an example of the screen outputted by the server device 110 (screen 2400).

The screen 2400 shows an example of a screen that appears when right clicking is performed on the function node B1912 on the screen 2300. A “display call graph” menu 2410, which visualizes the structure of the source codes 146, is displayed on the screen 2400.

FIG. 25 shows an example of the screen outputted by the server device 110 (screen 2500).

The screen 2500 shows an example of a screen that appears when the “display call graph” menu 2410 is selected on the screen 2400. The screen 2500 shows the source code nodes A2511, B2512, D2513, and C2514 relating to the function node B1912.

FIG. 26 shows an example of the screen outputted by the server device 110 (screen 2600).

The screen 2600 shows an example of the screen that appears when the “test item” and “TEST004” are specified as the search keyword and the search category, respectively, on the screen 1800 and the search is performed. On the screen 2600, a node of the search category and nodes relating to the node are displayed, and the node corresponding to the search keyword is highlighted. The present example shows that the test item node “004” 2611 relates to the function node B1912, the source code node B2512, and the source code node D2513, and the test item node “004” 2611, which is the search keyword, is highlighted.

According to the present embodiment, ensuring the traceability makes it easy to examine the influence of software modifications, and allows development of high-quality software in a short period of time.

### (II) Additional Remarks

The embodiment described above includes, for example, the contents below.

The aforementioned embodiment has been described above with reference to the case where the present invention is applied to a development assistance system, but not necessarily, and the present invention can be widely applied to a variety of other systems, devices, methods, and programs.

In the embodiment described above, part or the entirety of the program may be installed from a program source onto an device such as a computer that realizes the server device 110. The program source may, for example, be a networked program distribution server or a computer readable recording medium (non-transitory recording medium, for example). In the above description, two or more programs may be realized as one program, or one program may be realized as two or more programs.

In the embodiment described above, the configuration of each of the tables is presented by way of example, and one table may be divided into two or more tables, or all or part of two or more tables may be integrated into one table.

The screens illustrated and described in the aforementioned embodiment are presented by way of example, and may be designed in any manner as long as the information to be accepted is the same.

The screens illustrated and described in the aforementioned embodiment are presented by way of example, and may be designed in any manner as long as the information to be presented is the same.

In the embodiment described above, information is not necessarily outputted in the form of displayed information on a display. Information may be outputted in the form of audio output via a loudspeaker, outputted to a file, printed on a paper sheet or any other medium via a printing device, projected on a screen or any other surface via a projector, or outputted in any other aspect.

In the above description, programs, tables, files, and other pieces of information that realize the functions can be stored in a memory, a hard disk drive, an SSD (solid state drive), or any other storage device, or an IC card, an SD card, a DVD, or any other recording medium.

The embodiment described above, for example, has the following characteristic configurations.
(1)

A development assistance system includes a function information registration section that registers node information (node information 400, for example) for setting a function node (function node 406, for example) and edge information (edge information 410, for example) for setting an edge representing the relationship between function nodes based on document information (document and other information 140, for example) relating to predetermined software (function information registration section 119-1, processor 111, server device 110, circuit, and computer capable of communicating with server device 110, for example), a test item information registration section (test item information registration section 119-2, processor 111, server device 110, circuit, computer capable of communicating with server device 110) that registers node information for setting a test item node (test item node 408, for example) and edge information for setting an edge representing the relationship between a test item node and a function node based on test information (test item table 148, for example) containing a test item for performing a test on a function of the predetermined software, and a source code information registration section (source code information registration section 119-3, processor 111, server device 110, circuit, computer capable of communicating with server device 110) that registers node information for setting a source code node (source code node 407, for example) based on a source code (source code 146, for example) used in the predetermined software described above, and the source code information registration section described above reads execution trace information (execution trace 251 and execution trace table 500, for example) containing information that associates a source code (source code 146, for example) of a program with the test item described above for executing the test described above for a function of the predetermined software described above, the program running when the test is executed by a test execution system (test execution system 130, for example) based on the test information containing the test item, identifies the edge information with which a test item node representing a test item that coincides with the test item in the read execution trace information is associated from the edge information registered by the test item information registration section described above, identifies a function node with which the test item node described above is associated based on the identified edge information, and registers edge information for setting an edge representing the relationship between the identified function node and the source code node of the source code described above (see FIG. 11, for example).

In the configuration described above, for example, the function and the source code are automatically associated with each other by using an explanation note of the test content described in the test item and the test execution trace. No omission of the association operation or wrong association operation therefore occurs, whereby a correct relationship between a function and a source code is established. In addition, the association operation performed manually or by embedding tags is unnecessary, whereby high-quality software can be developed in a short period of time, and development and maintenance person-hours can be reduced.
(2)

The source code information registration section described above registers first edge information for setting a first edge representing the relationship between the source code node in the registered node information and the function node in the node information registered by the function information registration section described above from the document information relating to the source code used in the predetermined software described above (see FIG. 8, for example), and updates the first edge information described above by second edge information when there is a difference between the first edge information described above and second edge information described above, the second edge information being edge information for setting a second edge representing the relationship between the function node and the source code node described above, the second edge information registered based on the acquired execution trace information (see FIG. 11, for example).

In the configuration described above, the development assistance system, for example, associates existing documents to each other and complements the correct relationship between the documents based on the actual operation of the software by using a test item and an execution trace thereof. According to the configuration described above, for example, even when a deviation occurs between any of the documents and the implementation, so that the correct relationship is not provided, the correct relationship can be complemented based on the execution trace, whereby the traceability can be improved. Furthermore, for example, associating the edge information with identification information for identifying the documents used to set the edge, and outputting information on the documents identified by the identification information associated with the edge information to be updated allows the user to grasp the fact that the documents are old documents.
(3)

The function information registration section described above extracts a word representing the function of the predetermined software described above from the document information relating to the predetermined software described above, registers node information for setting the extracted word as a function node (see FIG. 6, for example), extracts the relationship between the function nodes in the registered node information from the document information relating to the predetermined software described above, registers edge information for setting an edge representing the extracted relationship between the function nodes (see FIG. 7, for example), and registers edge information for setting an edge representing the relationship between a first function node and a second function node when the function information registration section determines that the function of the first function node described above and the function of the second function node described above are similar to each other based on the similarity (cosine similarity, for example) of each word in the registered node information (see FIG. 12, for example).

In the configuration described above, which, for example, evaluates synonyms, whereby the user can readily determine whether functions having similar names are the same or different from each other.
(4)

The function information registration section described above evaluates whether or not the function of the first function node described above and the function of the second function node described above are similar to each other based on the similarity between the words in the registered node information (cosine similarity, for example) and similarity between a source code associated with the first function node described above and a source code associated with the second function node described above (implementation similarity, for example) (see FIG. 12, for example).

In the configuration described above, whether or not the functions are similar to each other is evaluated based on the similarity between the words and the similarity between the source codes, whereby synonyms can be evaluated more accurately.
(5)

The development assistance system includes an output section (output section 119-4, processor 111, server device 110, circuit, and computer capable of communicating with server device 110, for example) that identifies, based on information, inputted via a user interface (screen 1800, for example), on a function to be searched for (search category and search keyword, for example), node information on the function to be searched for from the node information registered by the function information registration section described above, identifies a source code node associated with the function node of the aforementioned function to be searched for from the edge information registered by the source code information registration section described above based on the identified node information, and outputs information representing the source code of the identified source code node (information representing source code 146 relating to selected function and displayed in source code tab 2013, for example, see FIG. 22).

According to the configuration described above, for example, information representing the source code relating to the function to be searched for is displayed, whereby the user can grasp the source code relating to the function to be searched for and can readily examine the effect at the time of software modifications.
(6)

Node information on a source code registered by the source code information registration section described above includes storage destination information (document URL, for example) representing the destination in which the source code described above is stored, the output section described above displays information representing the source code of the identified source code node on a display device, and when the information representing the displayed source code is selected, the output section displays the source code described above on the display device described above based on the storage destination information contained in the node information on the selected source code.

According to the configuration described above, for example, the user can readily grasp the content of the source code relating to the function to be searched for by selecting the information representing the displayed source code, whereby the period required to modify the software can be shortened.
(7)

The development assistance system described above includes the output section (output section 119-4, processor 111, server device 110, circuit, computer capable of communicating with server device 110, for example). The output section described above identifies, based on information, inputted via the user interface (screen 1800, for example), on a function to be searched for (search category and search keyword, for example), node information on the aforementioned function to be searched for from the node information registered by the function information registration section described above, identifies the second function node associated with the first function node of the aforementioned function to be searched for from the edge information registered by the function information registration section described above based on the identified node information on the function, couples the first function node described above and the second function node described above to each other and displays the function nodes on the display device (see screens 1900, 2000, 2100, 2200, and 2300, for example), identifies, when predetermined operation is performed on the displayed function node (for example, when right clicking is performed on displayed function node to select the “display call graph” menu), a source code node associated with the function node on which the predetermined operation described above has been performed, and couples the identified source code node to a source code node associated with a function node associated with the function node described above and displays the source code nodes on the display device described above (see FIG. 24, for example).

According to the configuration described above, for example, the structure of the source code is visualized, whereby the user can readily modify the source code.
(8)

The development assistance system described above includes the output section (output section 119-4, processor 111, server device 110, circuit, computer capable of communicating with server device 110, for example), and the output section described above identifies, based on the information, inputted via the user interface (screen 1800, for example), on the test item to be searched for (search category and search keyword, for example), node information on aforementioned the test item to be searched for from the node information registered by the test item information registration section described above, identifies a function node associated with the test item node of the test item described above from the edge information registered by the test item information registration section described above based on the identified node information on the test item, identifies the source code node associated with the test item node of the test item described above from the edge information registered by the source code information registration section described above based on the identified node information on the test item, and couples the function node described above and the source code node described above to the test item node described above and displays the nodes on the display device (see FIG. 26, for example).

According to the configuration described above, for example, when a test item is searched for, the test item is coupled to the function and the source code associated with the test item and the coupled test item, function, and the source code are displayed, whereby the user can readily grasp the function and the source code associated with the test item.
(9)

The development assistance system described above includes the output section (output section 119-4, processor 111, server device 110, circuit, computer capable of communicating with server device 110, for example). Test information containing a test item used to perform a test on a function of the predetermined software described above contains information representing the category of the function described above (see FIG. 3, for example). Node information on the test item described above contains information on the category of the function described above (see FIG. 4, for example), and the output section identifies, based on information, inputted via the user interface (screen 1800, for example), on a function to be searched for (search category and search keyword, for example), node information on the aforementioned function to be searched for from the node information registered by the function information registration section described above, identifies a test item node associated with a function node in the identified node information on the function from the edge information registered by the test item information registration section described above, displays the function node described above and information on the category of a function of the function node described above contained in the node information on the test item node described above (display area 2015, for example).

According to the configuration described above, for example, when the information on the category of the test type or any other factor relating to non-functional requirements is imparted to a test item table, the information on the category is also stored in the graph DB and displayed together with the result of the search, prompting the user to understand not only of the software functional specifications but also the non-functional requirements.

The configurations described above may be changed, recombined, combined, or omitted as appropriate to the extent that any of the operations does not depart from the substance of the present invention.

It should be understood that items contained in a list in the form “at least one of A, B, and C” may mean (A), (B), (C), (A and B), (A and C), (B and C), or (A, B, and C). Similarly, items contained in a list in the form of “at least one of A, B, or C” may mean (A), (B), (C), (A and B), (A and C), (B and C), or (A, B, and C).

What is claimed is:

1. A development assistance system comprising:
a function information registration section that registers node information for setting a function node and edge information for setting an edge representing a relationship between function nodes based on document information relating to predetermined software;
a test item information registration section that registers node information for setting a test item node and edge information for setting an edge representing a relationship between a test item node and a function node based on test information containing a test item for performing a test on a function of the predetermined software; and
a source code information registration section that registers node information for setting a source code node based on a source code used in the predetermined software,
wherein the source code information registration section
reads execution trace information containing information that associates a source code of a program with the test item for executing the test for a function of the predetermined software, the program running when the test is executed by a test execution system based on the test information containing the test item,
identifies the edge information with which a test item node representing a test item that coincides with the test item in the read execution trace information is associated from the edge information registered by the test item information registration section,
identifies a function node with which the test item node is associated based on the identified edge information, and
registers edge information for setting an edge representing a relationship between the identified function node and the source code node of the source code.

2. The development assistance system according to claim 1,
wherein the source code information registration section
registers first edge information for setting a first edge representing a relationship between the source code node in the registered node information and the function node in the node information registered by the function information registration section from the document information relating to the source code used in the predetermined software, and
updates the first edge information by second edge information when there is a difference between the first edge information and the second edge information, the second edge information being edge information for setting a second edge representing a relationship between the function node and the source code node, the second edge information registered based on the acquired execution trace information.

3. The development assistance system according to claim 1,
wherein the function information registration section
extracts a word representing the function of the predetermined software from the document information relating to the predetermined software, registers node information for setting the extracted word as a function node, extracts a relationship between the function nodes in the registered node information from the document information relating to the predetermined software, registers edge information for setting an edge representing the extracted relationship between the function nodes, and
registers edge information for setting an edge representing a relationship between a first function node and a second function node when the function information registration section determines that a function of the first function node and a function of the second function node are similar to each other based on similarity of each word in the registered node information.

4. The development assistance system according to claim 3,
wherein the function information registration section evaluates whether or not the function of the first function node and the function of the second function node are similar to each other based on the similarity between the words in the registered node information and similarity between a source code associated with the first function node and a source code associated with the second function node.

5. The development assistance system according to claim 1,
further comprising an output section that identifies, based on information, inputted via a user interface, on a function to be searched for, node information on the function to be searched for from the node information registered by the function information registration section, identifies a source code node associated with a function node of the function to be searched for from the edge information registered by the source code information registration section based on the identified node information, and outputs information representing a source code of the identified source code node.

6. The development assistance system according to claim 5,
wherein node information on a source code registered by the source code information registration section includes storage destination information representing a destination in which the source code is stored,
the output section displays information representing the source code of the identified source code node on a display device, and when the information representing the displayed source code is selected, the output section displays the source code on the display device based on the storage destination information contained in the node information on the selected source code.

7. The development assistance system according to claim 1, further comprising:
an output section,
wherein the output section
identifies, based on information, inputted via a user interface, on a function to be searched for, node information on the function to be searched for from the node information registered by the function information registration section,
identifies a second function node associated with a first function node of the function to be searched for from the edge information registered by the function information registration section based on the identified node information on the function, couples the first function node and the second function node to each other, and displays the function nodes on a display device,
identifies, when predetermined operation is performed on the displayed function node, a source code node associated with the function node on which the predetermined operation has been performed, and
couples the identified source code node to a source code node associated with a function node associated with the function node and displays the source code nodes on the display device.

8. The development assistance system according to claim 1, further comprising:
an output section,
wherein the output section
identifies, based on information, inputted via a user interface, on a test item to be searched for, node information on the test item to be searched for from the node information registered by the test item information registration section,
identifies a function node associated with the test item node of the test item from the edge information registered by the test item information registration section based on the identified node information on the test item,
identifies a source code node associated with the test item node of the test item from the edge information registered by the source code information registration section based on the identified node information on the test item, and
couples the function node and the source code node to the test item node and displays the nodes on a display device.

9. The development assistance system according to claim 1, further comprising:
an output section,
wherein test information containing a test item used to perform a test on a function of the predetermined software contains information representing a category of the function,
node information on the test item contains information on the category of the function, and
the output section
identifies, based on information, inputted via a user interface, on a function to be searched for, node information on the function to be searched for from the node information registered by the function information registration section,
identifies a test item node associated with a function node in the identified node information on the function from the edge information registered by the test item information registration section, and
displays the function node and information on a category of a function of the function node contained in the node information on the test item node.

10. A development assistance method, comprising:
by a function information registration section, registering node information for setting a function node and edge information for setting an edge representing a relationship between function nodes based on document information relating to predetermined software;
by a test item information registration section, registering node information for setting a test item node and edge information for setting an edge representing a relationship between a test item node and a function node based on test information containing a test item for performing a test on a function of the predetermined software; and
by a source code information registration section, registering node information for setting a source code node based on a source code used in the predetermined software,
wherein the source code information registration section
reads execution trace information containing information that associates a source code of a program with the test item for executing the test for a function of the predetermined software, the program running when the test is executed by a test execution system based on the test information containing the test item,
identifies the edge information with which a test item node representing a test item that coincides with the test item in the read execution trace information is associated from the edge information registered by the test item information registration section,
identifies a function node with which the test item node is associated based on the identified edge information, and
registers edge information for setting an edge representing a relationship between the identified function node and the source code node of the source code.
